(19) United States
(12) Patent Application Publication
(10) Pub. No.: US 2015/0309703 A1
(43) Pub. Date: Oct. 29, 2015

(54) MUSIC CREATION SYSTEMS AND METHODS

(71) Applicants: Thomas P. ROBERTSON, (US); Kyle J. JOHNSEN, (US); Adam BROWN, (US); Brian RUGGIERI, (US); UNIVERSITY OF GEORGIA RESEARCH FOUNDATION INC., Athens, GA (US)

(72) Inventors: Thomas P. Robertson, Athens, GA (US); Kyle J. Johnsen, Athens, GA (US); Adam Brown, Athens, GA (US); Brian Ruggieri, Athens, GA (US)

(21) Appl. No.: 14/648,040

(22) PCT Filed: Nov. 29, 2013
(86) PCT No.: PCT/US2013/072481

§ 371 Date: May 28, 2015

Related U.S. Application Data
(60) Provisional application No. 61/731,214, filed on Nov. 29, 2012.

(51) Int. Cl. G06F 3/0484; G06F 3/0481

(52) U.S. Cl. CPC G06F 3/04842; G06F 3/04817

(57) ABSTRACT

The exemplary systems and methods allow a user to create music using continuous sound structures and other graphical elements using a graphical user interface. The method comprises: depicting a music portion space in the graphical user interface of a display apparatus for creating a portion of music; and allowing the user, using an input apparatus, to add one or more continuous sound structures to the music portion space, wherein each of the one or more continuous sound structures comprises a plurality of sound elements arranged around a continuous loop representing a period of time.

### CROSS-REFERENCE TO RELATED APPLICATION

This application claims the benefit of U.S. Provisional Patent Application 61/731,214 filed on 29 Nov. 2012 and entitled “MUSIC CREATION SYSTEMS AND METHODS,” which is incorporated herein by reference in its entirety.

### BACKGROUND

The disclosure herein relates to music creation systems (e.g., tablet or pad-based computing devices), methods, and graphical user interfaces.

### SUMMARY

The present disclosure relates to music creation systems and methods including graphical user interfaces configured for user interaction to create music. The graphical user interface may define one or more regions or spaces used to create music that may relate to one or more characteristics of the music being created. For example, a music portion space may be depicted in the graphical user interface and one or more continuous sound structures may be added to the space. If a sound structure is moved up or down vertically within the space, the volume of the sound structure may be adjusted up or down, respectively. Likewise, if a sound structure is moved left or right horizontally within the space, the spatial location of the origin of the sounds representative by the sound structure may be adjusted left or right, respectively (e.g., between left and right speakers, within a multi-channel spatial arrangement of speakers, etc.).

The exemplary systems and methods described herein may be described as being able to provide users with the ability to record, arrange, and mix an entire song via an intuitive interface, which may be accomplished through touches, swipes, and fractal patterning to drive the majority of music design. Further, the exemplary embodiments may capture the essence of music creation and may project the music creation as a visual representation in a three-dimensional music space. Alongside the intuitiveness of the exemplary systems and methods, the touch-based design of one or more exemplary systems and methods may create an efficient music production application.

It may be described that the present disclosure relates to an intuitive touch-based digital audio workstation (DAW) that streamlines music-making and recording processes for its users. In at least one embodiment, the DAW maintains an innovative fractal design (e.g., based on a “sound orb” template) that allows a user to visualize the music creation, arrangement, and mixing process in a three-dimensional space.

In one or more embodiments, the exemplary DAW may provide greater precision in songwriting, decreased time for production, greater visual understanding of the “wall of sound,” and a complete manipulation of a spatiotemporal music space.

One exemplary system for allowing a user to create music may include computing apparatus configured to generate music, sound output apparatus operatively coupled to the computing apparatus and configured to output sound generated by the computing apparatus, an input interface operatively coupled to the computing apparatus and configured to allow a user to create a portion of music, and a display apparatus operatively coupled to the computing apparatus and configured to display a graphical user interface. The computing apparatus may be configured to depict a music portion space in the graphical user interface of the display apparatus for creating the portion of music, and allow a user, using the input apparatus, to add one or more continuous sound structures to the music portion space. Each of the one or more continuous sound structures may include a plurality of sound elements arranged around a continuous loop representing a period of time.

One exemplary method for allowing a user to create music may include depicting a music portion space in a graphical user interface of a display apparatus for creating a portion of music and allow a user, using input apparatus, to add one or more continuous sound structures to the music portion space. Each of the one or more continuous sound structures may include a plurality of sound elements arranged around a continuous loop representing a period of time.

Exemplary logic encoded in one or more non-transitory media that includes code for execution and when executed by a processor operable to perform operations may include depicting a music portion space in a graphical user interface of a display apparatus for creating a portion of music and allow a user, using input apparatus, to add one or more continuous sound structures to the music portion space. Each of the one or more continuous sound structures may include a plurality of sound elements arranged around a continuous loop representing a period of time.

In one or more exemplary systems, methods, or logic, the computing apparatus may be further configured to execute or the method or logic may further include allowing a user, using the input apparatus, to move each continuous sound structure of the one or more continuous sound structures vertically within the music portion space to adjust the volume of the continuous sound structure.

In one or more exemplary systems, methods, or logic, the computing apparatus may be further configured to execute or the method or logic may further include depicting a sound structure addition area on the graphical user interface for displaying a plurality of continuous sound structures to be used in the music portion space to create the portion of music and allowing a user, using the input apparatus, to add one or more continuous sound structures to the music portion space using the sound structure addition area.

In one or more exemplary systems, methods, or logic, the computing apparatus may be further configured to execute or the method or logic may further include allowing a user, using the input apparatus, to move each continuous sound structure of the one or more continuous sound structures horizontally within the music portion space to adjust the spatial orientation of the continuous sound structure.

In one or more exemplary systems, methods, or logic, the computing apparatus may be further configured to execute or the method or logic may further include depicting a tempo adjustment area on the graphical user interface for displaying a tempo of the portion of music and allowing a user, using the input apparatus, to adjust the tempo of the portion of music using the tempo adjustment area of the graphical user interface.

In one or more exemplary systems, methods, or logic, the computing apparatus may be further configured to execute or the method or logic may further include depicting a music portion movement area on the graphical user interface for displaying additional music portions and allowing, using the input apparatus, a user to switch to another music portion and to add another music portion using the music portion movement area of the graphical user interface.

In one or more exemplary systems, methods, or logic, the computing apparatus may be further configured to execute or the method or logic may further include allowing, using the input apparatus, a user to select a continuous sound structure from the music portion space to edit the continuous sound structure.

One exemplary system for allowing a user to create music may include computing apparatus configured to generate music, sound output apparatus operatively coupled to the computing apparatus and configured to output sound generated by the computing apparatus, an input interface operatively coupled to the computing apparatus and configured to allow a user to edit a continuous sound structure, and a display apparatus operatively coupled to the computing apparatus and configured to display a graphical user interface. The computing apparatus may be configured to depict the continuous sound structure on the graphical user interface, wherein the continuous sound structure may include a plurality of sound elements arranged around a continuous loop representing a period of time. Each of the plurality of sound elements may be configurable using the input apparatus between an enabled configuration and a disabled configuration. When a sound element is in the enabled configuration, the enabled sound element may represent a sound to be output at the moment of time within the period of time where the enabled sound element is located in the continuous loop. The computing apparatus may be further configured to allow, using the input apparatus, a user to select one or more of the plurality of sound elements to configure the one or more sound elements in the enabled or disabled configurations.

One exemplary method for allowing a user to create music may include depicting a continuous sound structure on the graphical user interface. The continuous sound structure may include a plurality of sound elements arranged around a continuous loop representing a period of time. Each of the plurality of sound elements may be configurable using the input apparatus between an enabled configuration and a disabled configuration. When a sound element is in the enabled configuration, the enabled sound element may represent a sound to be output at the moment of time within the period of time where the enabled sound element is located in the continuous loop. The exemplary method may further include allowing, using an input apparatus, a user to select one or more of the plurality of sound elements to configure the one or more sound elements in the enabled or disabled configurations.

Exemplary logic encoded in one or more non-transitory media that includes code for execution and when executed by a processor operable to perform operations may include depicting a continuous sound structure on the graphical user interface. The continuous sound structure may include a plurality of sound elements arranged around a continuous loop representing a period of time. Each of the plurality of sound elements may be configurable using the input apparatus between an enabled configuration and a disabled configuration. When a sound element is in the enabled configuration, the enabled sound element may represent a sound to be output at the moment of time within the period of time where the enabled sound element is located in the continuous loop. The exemplary logic encoded in one or more non-transitory media that includes code for execution and when executed by a processor operable to perform operations may further include allowing, using an input apparatus, a user to select one or more of the plurality of sound elements to configure the one or more sound elements in the enabled or disabled configurations.

In one or more exemplary systems, methods, or logics the computing apparatus may be further configured to execute or the method or logic may further include allowing, using the input apparatus, a user to change the pitch of one or more sound elements of the plurality of sounds elements.

In one or more exemplary systems, methods, or logics the computing apparatus may be further configured to execute or the method or logic may further include, when a user changes the pitch of a sound element, the depth of the sound element may be changed in the graphical user interface (e.g., the three-dimensional depth of the sound element may be changed, projecting into or out of the display pane, etc.).

In one or more exemplary systems, methods, or logics the computing apparatus may be further configured to execute or the method or logic may further include depicting a sound effect addition area on the graphical user interface for displaying a plurality of sound effects to be used to modify one or more sound elements of the plurality of sounds elements and allowing, using the input apparatus, a user to add one or more sound effects to one or more sound elements space using the sound effect addition area.

In one or more exemplary systems, methods, or logics the computing apparatus may be further configured to execute or the method or logic may further include displaying a volume adjustment element and allowing, using the input apparatus, a user to adjust the volume of the continuous sound structure using the volume adjustment element.

One exemplary system for allowing a user to create music may include computing apparatus configured to generate music, sound output apparatus operatively coupled to the computing apparatus and configured to output sound generated by the computing apparatus, an input interface operatively coupled to the computing apparatus and configured to allow a user edit a continuous music arrangement to create music, and a display apparatus operatively coupled to the computing apparatus and configured to display a graphical user interface. The computing apparatus may be configured to depict the continuous music arrangement. The continuous music arrangement may include a plurality of locations arranged around a continuous loop representing a period of time. The computing apparatus may be further configured to allow a user, using the input apparatus, to add one or more music portions to one or more locations of the plurality of locations of the continuous music arrangement and allow a user, using the input apparatus, to increase or decrease an amount of locations of the plurality of locations of the continuous music arrangement.

One exemplary computer-implemented method for allowing a user to create music may include depicting a continuous music arrangement. The continuous music arrangement may include a plurality of locations arranged around a continuous loop representing a period of time. The exemplary method may further include allowing a user, using an input apparatus, to add one or more music portions to one or more locations of the plurality of locations of the continuous music arrangement and allowing a user, using the input apparatus, to increase or decrease an amount of locations of the plurality of locations of the continuous music arrangement.

Exemplary logic encoded in one or more non-transitory media that includes code for execution and when executed by a processor operable to perform operations may include depicting a continuous music arrangement. The continuous music arrangement may include a plurality of locations arranged around a continuous loop representing a period of time. The exemplary logic encoded in one or more non-transitory media that includes code for execution and when executed by a processor operable to perform operations may further include allowing a user, using an input apparatus, to add one or more music portions to one or more locations of the plurality of locations of the continuous music arrangement and allowing a user, using the input apparatus, to increase or decrease an amount of locations of the plurality of locations of the continuous music arrangement.

In one or more exemplary systems, methods, or logics, the computing apparatus may be further configured to execute or the methods or logics may further include depicting a music portion addition area on the graphical user interface for displaying a plurality of music portions and allowing a user, using the input apparatus, to add one or more music portions to one or more locations of the plurality of locations of the continuous music arrangement using the music portion addition area.

The above summary of the present disclosure is not intended to describe each disclosed embodiment or every implementation of the present disclosure. The description that follows more particularly exemplifies illustrative embodiments and not limiting applications.

### BRIEF DESCRIPTION OF THE DRAWINGS

FIG. 1 is a block diagram of an exemplary extracorporeal music creation system including input apparatus, display apparatus, and sound output apparatus that may utilize the graphical user interfaces and methods described herein.

FIG. 2 is a diagrammatic illustration of one or more modes of operation of graphical user interfaces as described herein.

FIGS. 3A-3D are screenshots of exemplary graphical user interfaces for the Loop Mode of FIG. 2.

FIG. 4 is a screenshot of an exemplary graphical user interface for the Edit Mode of FIG. 2.

FIG. 5 is a screenshot of an exemplary graphical user interface for the Arrangement Mode of FIG. 2.

FIG. 6 is another screenshot of an exemplary graphical user interface for the Edit Mode of FIG. 2.

FIG. 7 is a portion of the exemplary graphical user interface of FIGS. 3A-3D depicting a tempo adjustment area.

FIG. 8 is a screenshot of an exemplary graphical user interface for a configuration menu, e.g., accessible from the Loop Mode of FIG. 3A.

FIG. 9 is a screenshot of another exemplary graphical user interface for the Loop Mode of FIG. 2.

FIG. 10 is a portion of the exemplary graphical user interface of FIGS. 3A-3D depicting a music portion movement area.

FIG. 11 is a portion of the exemplary graphical user interface of FIGS. 3A-3D depicting a sound structure addition area.

FIG. 12 depicts exemplary continuous sound structures for the Edit Mode of FIG. 2.

FIG. 13 is a portion of the exemplary graphical user interface of FIGS. 3A-3D depicting another sound structure addition area.

FIGS. 14A-14B are screenshots of exemplary graphical user interfaces for the Song Mode of FIG. 2.

FIG. 15 is an overheard view of a depiction of a user moving an exemplary system within an exemplary music portion space.

### DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

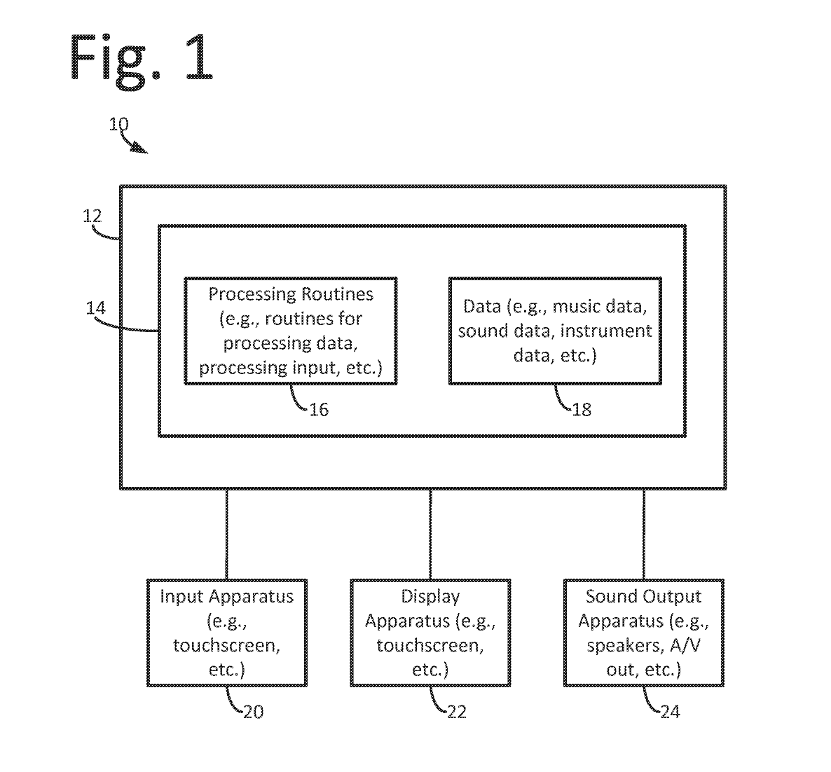

Exemplary methods, apparatus, and systems shall be described with reference to FIGS. 1-15. It will be apparent to one skilled in the art that elements or processes from one embodiment may be used in combination with elements or processes of the other embodiments, and that the possible embodiments of such methods, apparatus, and systems using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

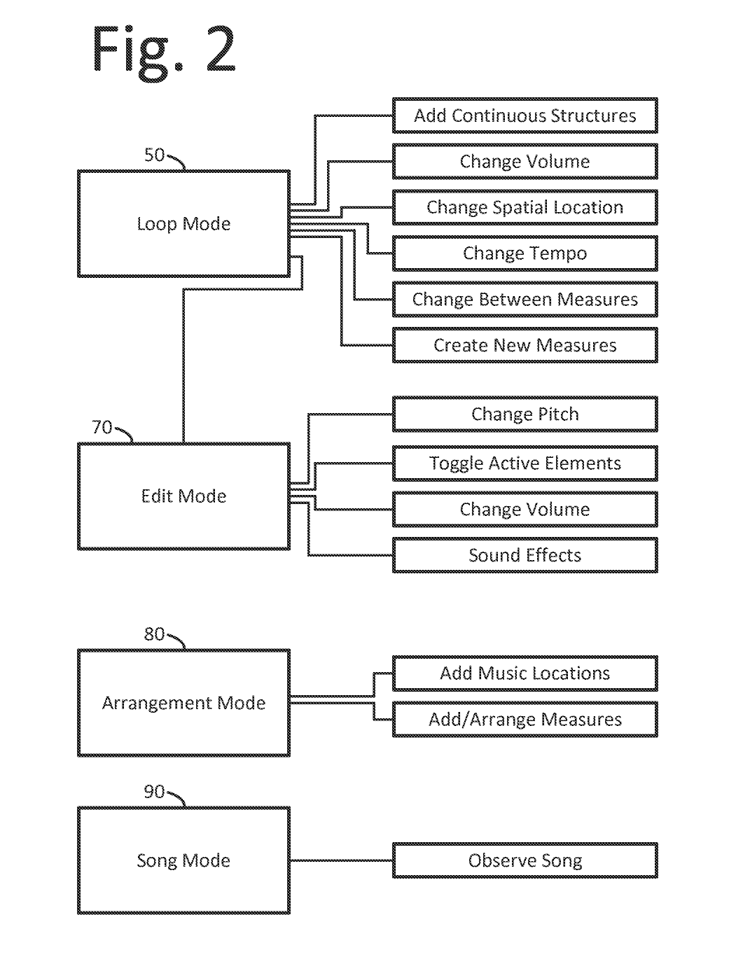

An exemplary computer system 10 depicted in FIG. 1 may be used to execute the exemplary methods and/or processes described herein. As shown, the exemplary computer system 10 includes computing apparatus 12. The computing apparatus 12 may be configured to receive input from input apparatus 20 and transmit output to display apparatus 22 and sound output apparatus 24. Further, the computing apparatus 12 includes data storage 14. Data storage 14 allows for access to processing programs or routines 16 and one or more other types of data 18 that may be employed to carry out exemplary methods and/or processes for use in creating music and/or sounds (e.g., some of which are shown generally in FIGS. 2-15). For example, the computing apparatus 12 may be configured to generate music based on input from a user using the input apparatus 20 to manipulate graphics depicted by the display apparatus 22.

The computing apparatus 12 may be operatively coupled to the input apparatus 20, the display apparatus 22, and the sound output apparatus 24. For example, the computing apparatus 12 may be electrically coupled to each of the input apparatus 20, the display apparatus 22, and the sound output apparatus 24 using, e.g., analog electrical connections, digital electrical connections, wireless connections, bus-based connections, etc. As described further herein, a user may provide input to the input apparatus 20 to manipulate, or modify, one or more graphical depictions displayed on the display apparatus 22 to create and/or modify sounds and/or music that may be outputted by the sound output apparatus 24.

Further, various peripheral devices may be operatively coupled to the computing apparatus 12 to be used within the computing apparatus 12 to perform the functionality, methods, and/or logic described herein. As shown, the system 10 may include input apparatus 20, display apparatus 22, and sound output apparatus 24. The input apparatus 20 may include any apparatus capable of providing input to the computing apparatus 12 to perform the functionality, methods, and/or logic described herein. For example, the input apparatus 20 may include a touchscreen (e.g., capacitive touchscreen, a resistive touchscreen multi-touch touchscreen, etc.), a mouse, a keyboard, a trackball, etc. Likewise, the display apparatus 22 may include any apparatus capable of displaying information to a user, such as a graphical user interface, etc., to perform the functionality, methods, and/or logic described herein. For example, the display apparatus 22 may include a liquid crystal display, an organic light-emitting diode screen, a touchscreen, a cathode ray tube display, etc. Further, the sound output apparatus may be any apparatus capable of outputting sound in any form (e.g., actual sound waves, analog or digital electrical signals representative of sound, etc.) to perform the functionality, methods, and/or logic described herein. For example, the sound output apparatus may include an analog connection for outputting one or more analog sound signals (e.g., 2.5 or 3.5 millimeter mono or stereo output, etc.), a digital connection for outputting one or more digital sound signals (e.g., optical digital output such as TOSLINK, HDMI, etc.), one or more speakers (e.g., stereo speakers, multi-channel speakers, surround sound speakers, etc.), etc.

The processing programs or routines 16 may include programs or routines for performing computational mathematics, matrix mathematics, standardization algorithms, comparison algorithms, vector mathematics, numeration, mathematical dynamics & entropy, pattern sequencing, data distribution, or any other processing required to implement one or more exemplary methods and/or processes described herein. Data 18 may include, for example, sound data, music data, instrument data, tempo data, sound frequency distribution data, sound processing data, stereo panning/sound positioning data, sound pitch data, graphics (e.g., 3D graphics, etc.), graphical user interfaces, results from one or more processing programs or routines employed according to the disclosure herein, or any other data that may be necessary for carrying out the one and/or more processes or methods described herein.

In one or more embodiments, the system 10 may be implemented using one or more computer programs executed on programmable computers, such as computers that include, for example, processing capabilities, data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or methods as described herein or as would be applied in a known fashion.

The program used to implement the methods and/or processes described herein may be provided using any programmable language, e.g., a high level procedural and/or object orientated programming language that is suitable for communicating with a computer system. Any such programs may, for example, be stored on any suitable device, e.g., a storage media, that is readable by a general or special purpose program running on a computer system (e.g., including processing apparatus) for configuring and operating the computer system when the suitable device is read for performing the procedures described herein. In other words, at least in one embodiment, the system 10 may be implemented using a computer readable storage medium, configured with a computer program, where the storage medium so configured causes the computer to operate in a specific and predefined manner to perform functions described herein. Further, in at least one embodiment, the system 10 may be described as being implemented by logic (e.g., object code) encoded in one or more non-transitory media that includes code for execution and when executed by a processor operable to perform operations such as the methods, processes, and/or functionality described herein.

Likewise, the system 10 may be configured at a remote site (e.g., an application server) that allows access by one or more users via a remote computer apparatus (e.g., via a web browser), and allows a user to employ the functionality according to the present disclosure (e.g., user accesses a graphical user interface associated with one or more programs to process data).

The computing apparatus 12, may be, for example, any fixed or mobile computer system (e.g., a tablet computer, a pad computer, a personal computer, a mini computer, an APPLE IPAD tablet computer, an APPLE IPHONE cellular phone, an APPLE IPOD portable device, a GOOGLE ANDROID tablet, a GOOGLE ANDROID portable device, a GOOGLE ANDROID cellular phone, etc.). The exact configuration of the computing apparatus 12 is not limiting, and essentially any device capable of providing suitable computing capabilities and control capabilities may be used.

Further, in one or more embodiments, the output generated by the computing apparatus 12 (e.g., sound or music files, etc.) may be analyzed by a user, used by another machine that provides output based thereon, etc. As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by computing apparatus 12 described herein. Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the processes described herein shall not be limiting on the scope of the systems, processes or programs (e.g., the functionality provided by such systems, processes or programs) described herein.

One will recognize that a graphical user interface may be used in conjunction with the embodiments described herein. The user interface may provide various features allowing for user input thereto, change of input, importation or exportation of files, or any other features that may be generally suitable for use with the processes described herein. For example, the user interface may allow default values to be used or may require entry of certain values, limits, threshold values, or other pertinent information.

The methods and/or logic described in this disclosure, including those attributed to the systems, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

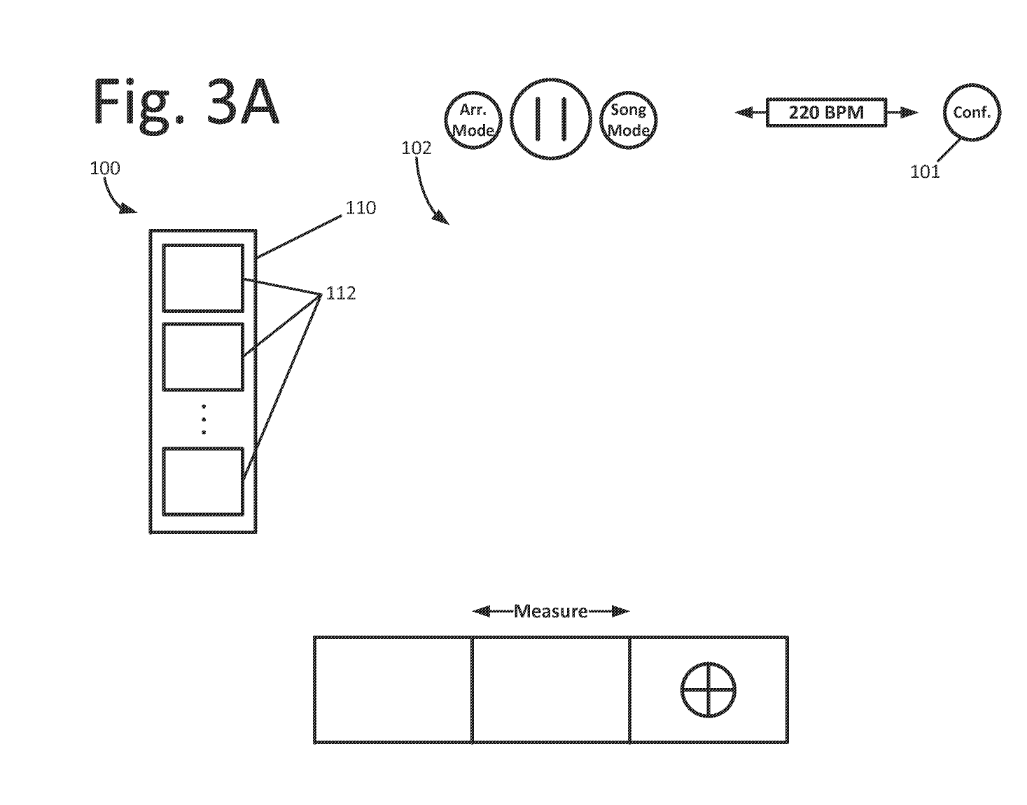

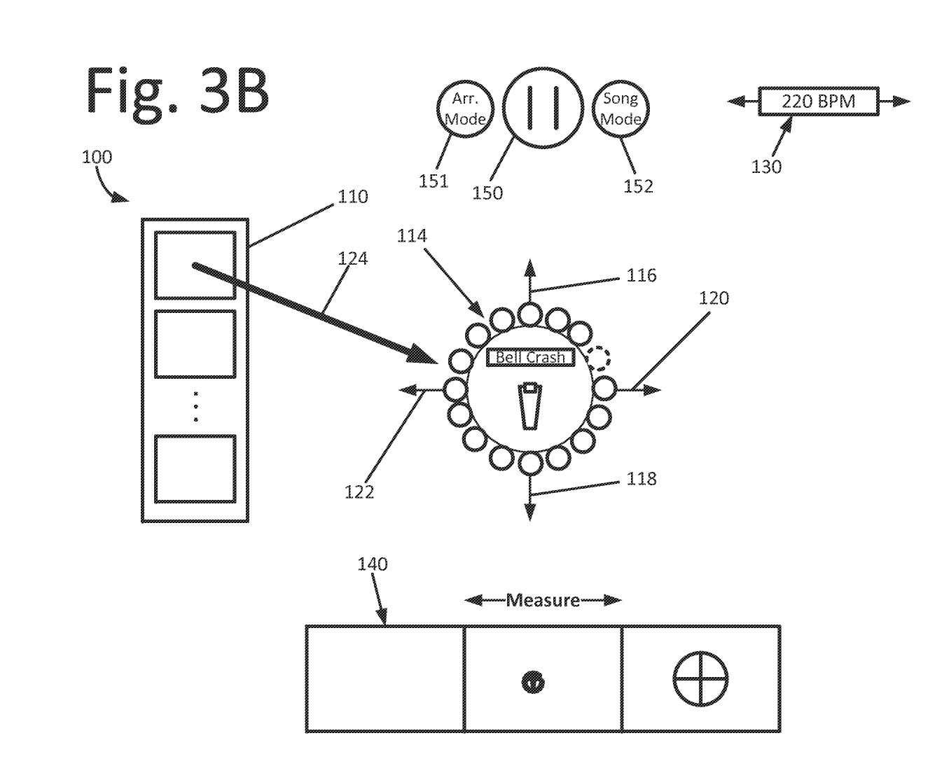

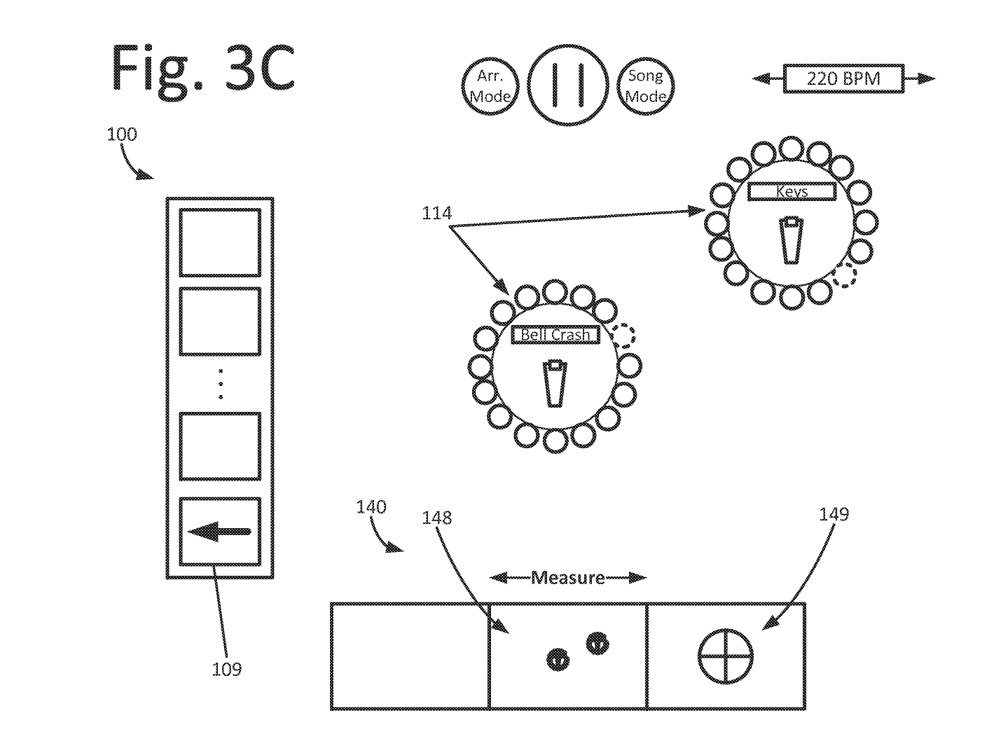

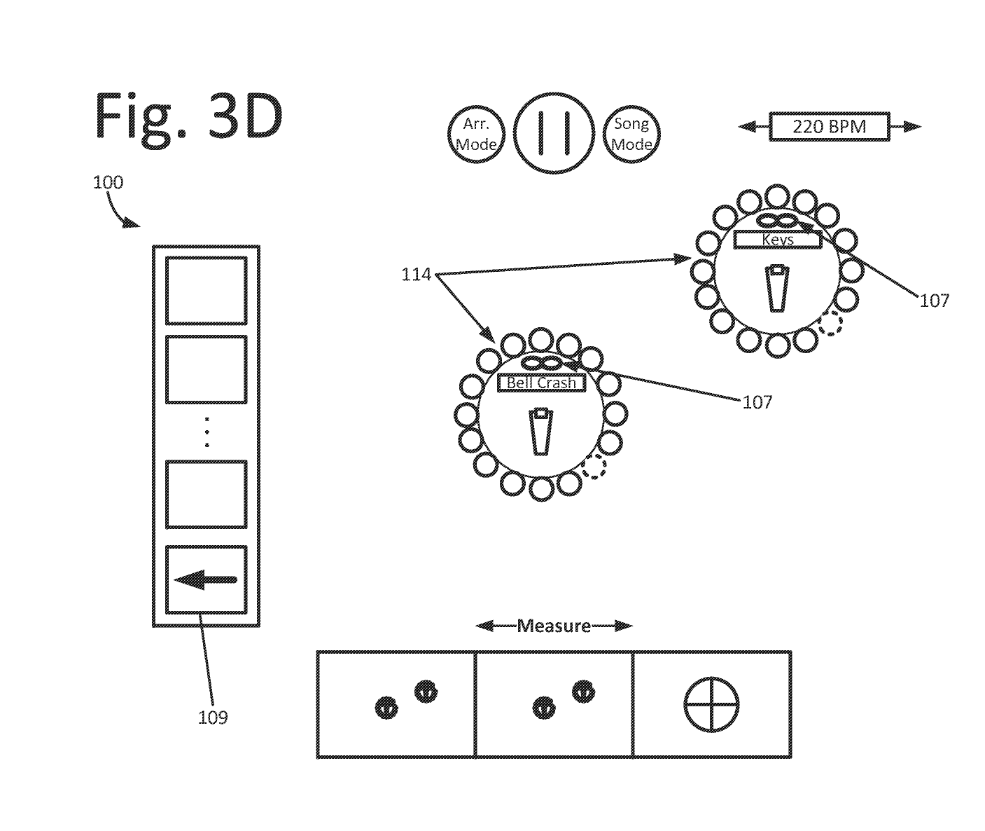

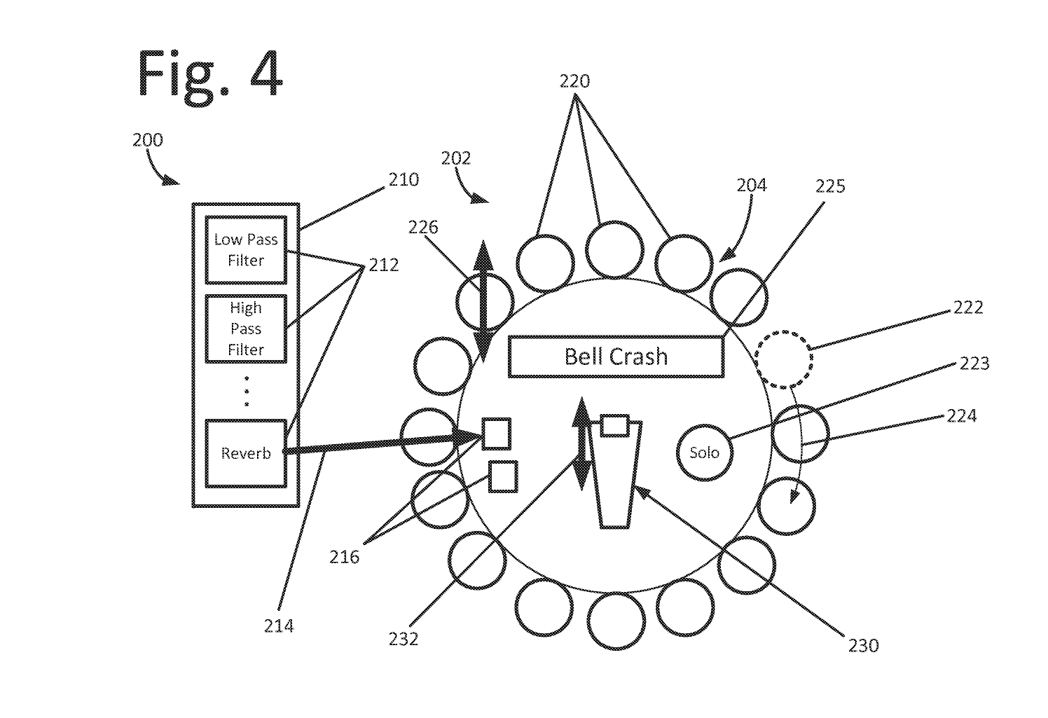

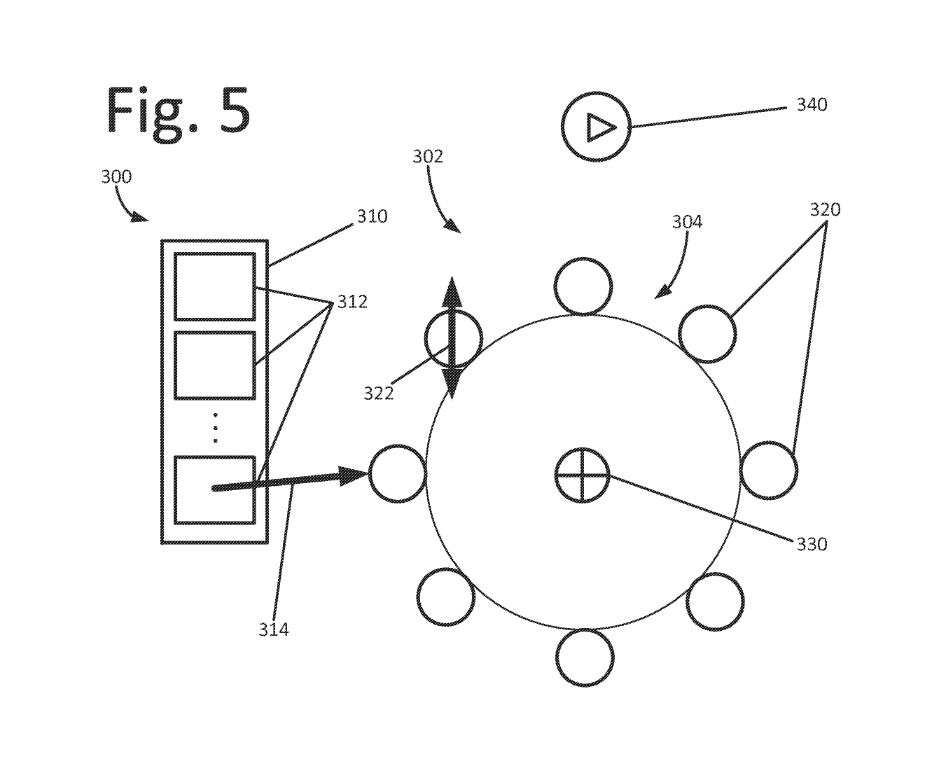

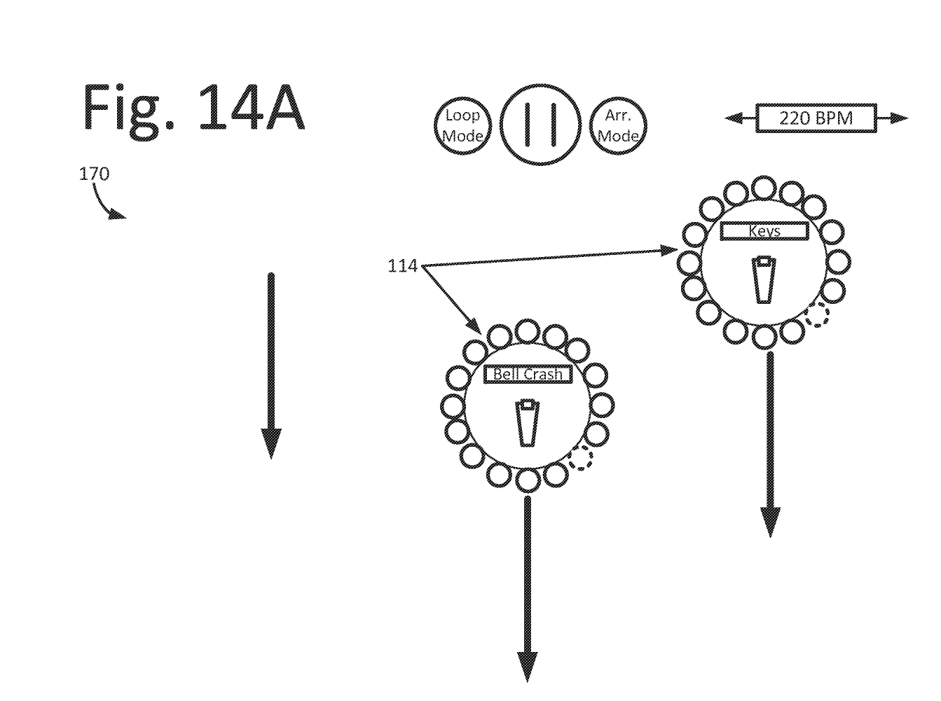

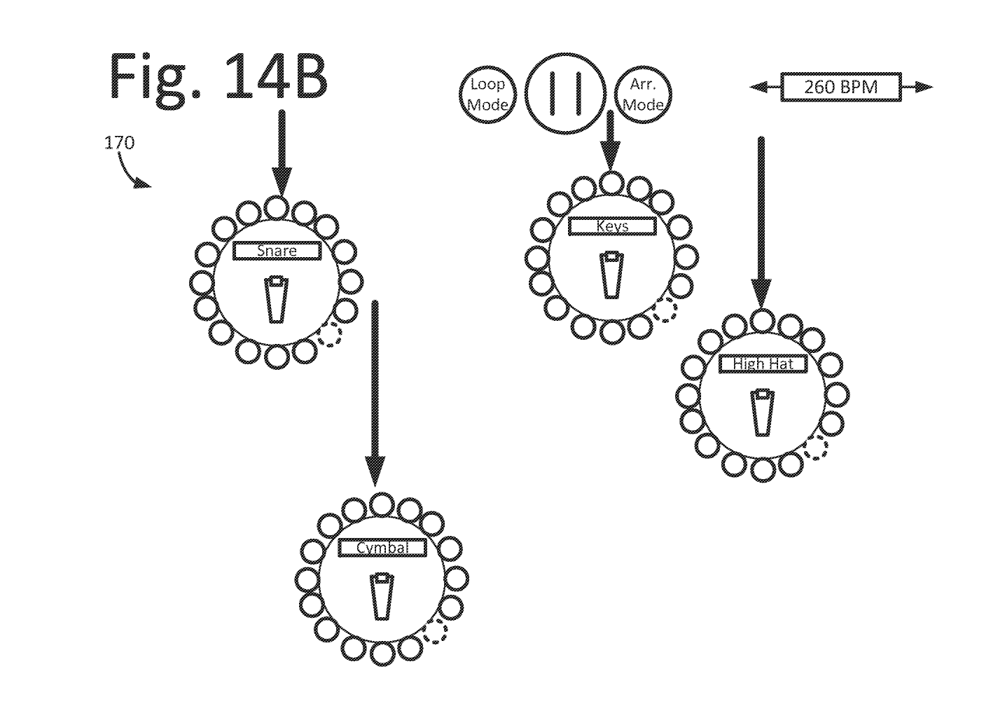

The exemplary systems, methods, and logic for use in creating music described herein may include multiple modes as depicted in FIG. 2. For example, the exemplary systems, methods, and logic may include a Loop Mode 50 for editing a music portion space as described herein with reference to FIGS. 3A-3C, an Edit Mode 70 for editing a continuous sound structure as described herein with reference to FIG. 4, an Arrangement Mode 80 as described herein with reference to FIG. 5, and a Song Mode 90 as described herein with reference to FIGS. 14A-14B. Each of the modes 50, 70, 80, 90 may include one or more functions that a user may utilize to create, edit, and/or visualize music as shown in FIG. 2 and further described herein with reference to FIGS. 3-15.

For example, the Loop Mode 50 may allow a user to add sound structures to a music portion space, change the volume of the sound structures, change the spatial location of the sound structures, change the tempo of the music portion space, change between measures or music portion spaces, and/or create new measures or music portion spaces. The Edit Mode 70 may be accessed after adding a sound structure to a music portion space (e.g., by selecting, or touching, a sound structure), which may bring the sound structure forward (e.g., the graphical user interface may zoom into view the sound structure more closely). The Edit Mode 70 may allow a user change the pitch of one or more sound elements of the sound structure, toggle one or more sound elements from being active or inactive within the sound structure, change the volume of the sound structure, and/or apply sound effects to the sound structure and/or sound elements of the sound structure. The Arrangement Mode 80 may allow a user to add one or more music locations and/or add and arrange any music portions or measures previously created to, e.g., create an arrangement of music or song. After an arrangement or song has been created, it may be visually depicted using a graphical user interface such that a user may observe the song graphically while it is played, or output, through sound output apparatus.

As shown in FIG. 3A, a graphical user interface (GUI) 100 may be displayed in Loop Mode 50 in which as user may create and/or edit music. The GUI 100 may depict a music portion space 102 for creating a portion, or measure, of music. In at least one embodiment, the music portion space 102 may define a three-dimensional space extending up to 360 degrees about a central location. For example, the GUI 100 may depict a portion of the 360 degree music portion space 102. If the GUI 100 is depicted on a tablet computer including a gyroscope and/or other position sensors, a user may be able to physically move the tablet computer left or right (e.g., rotate) around the central location to view more of the 360 degree, three-dimensional music portion space 102.

The exemplary systems and methods may always begin in Loop Mode 50. Loop Mode 50 may be defined as being the music portion, or measure, building mode, while a music portion/measure may be defined as a collection of continuous sound structures, or sound orbs, placed amongst a 360° music portion space 102. Loop Mode 50 may be described as the place where new music portions, or measures, may be created/added and/or where sounds within the music portions are edited.

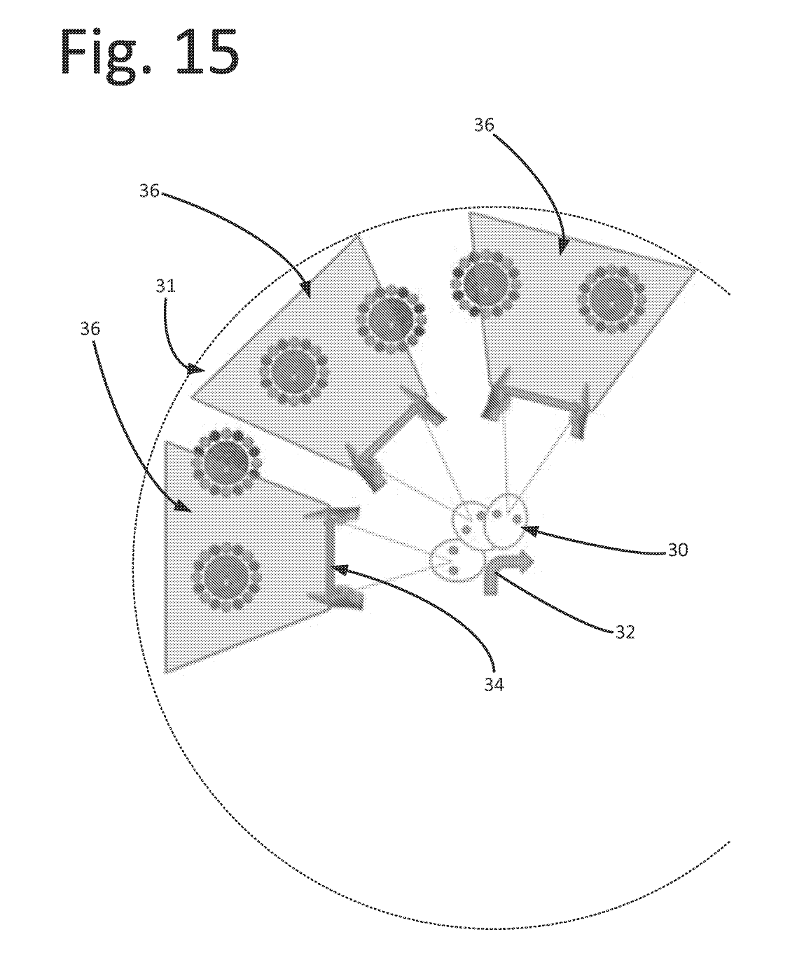

Part of a music portion space 31 is depicted in FIG. 15. The music portion space 31 extends 360 degrees about a user 30. As shown the user 30 is holding a tablet computer 34 configured to provide the GUI and software described herein in three different positions about the music portion space 31. In each position, a region, or window, 36 of the music portion space 31 is depicted on the graphical user interface. As the user 30 rotates 32 the tablet computer 34 about the music portion space 31, a different region 36 of the music portion space 31 is depicted. The music portion space 31 may be described as being a circle, e.g., as represented by the dotted line circle about the user 30 as shown in FIG. 15.

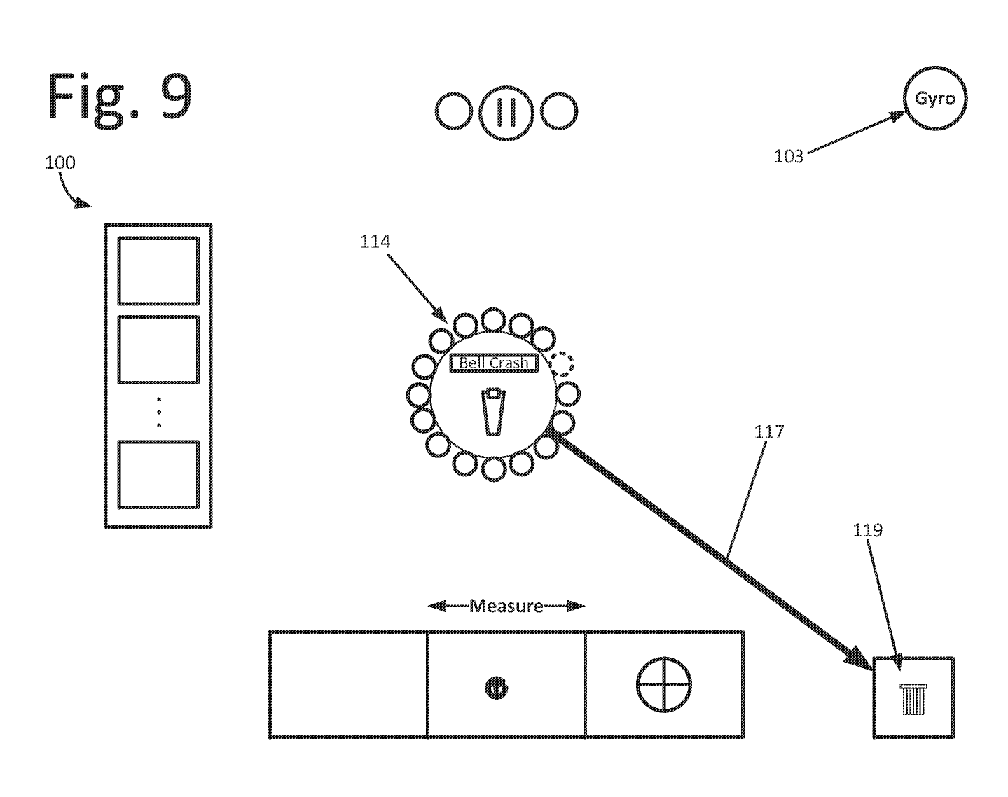

As shown in FIG. 9, a gyro area, or button, 103 may be located on the GUI 100 (on devices with gyroscopic features), which may, e.g., toggle camera controls between touch input and device orientation as shown in FIG. 15. The gyro option may allow a user to fully experience the 360° music making environment, and specifically how sounds structures, or sound orbs, are located around the user. This gyro feature may turn the tablet device into a “window” into the music portion space where sounds can be placed at any position around or about the user.

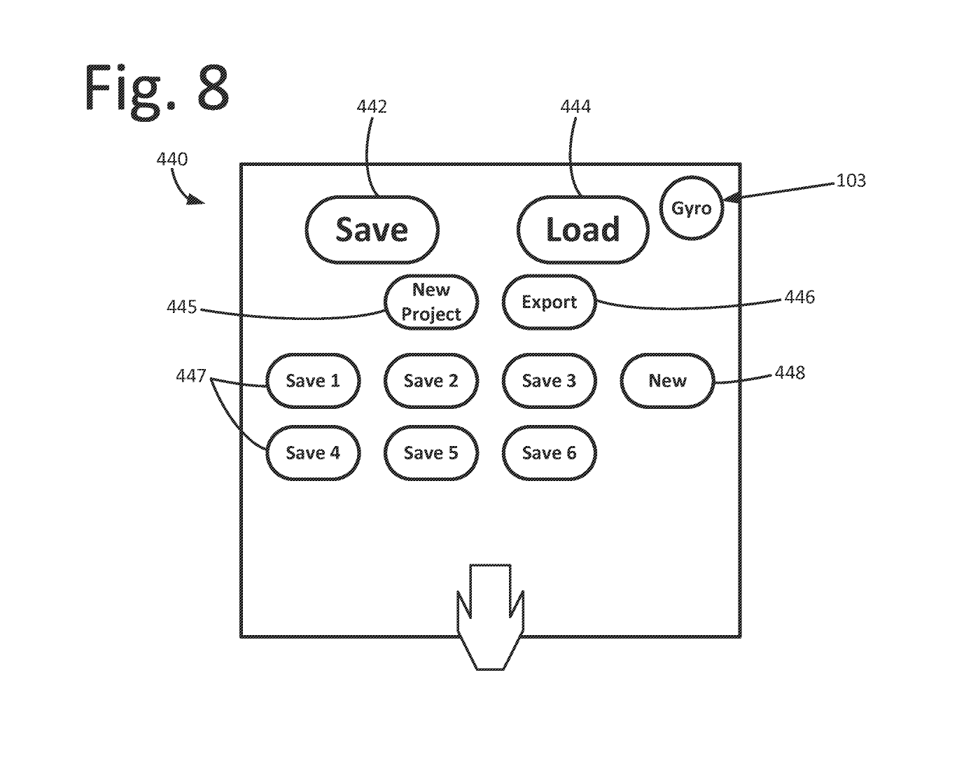

As shown in FIG. 3A, an exemplary GUI 100 for the Loop Mode 50, or Loop Mode GUI, may include a sound structure addition area 110 including one or more (e.g., a plurality) sound structures, or sounds, 112 (e.g., bass, keys, drums, etc.) that may be used to create music. The Loop Mode GUI 100, as well as other GUs described herein, may include a configuration area 101 that may be selected to access one or more configuration options for the systems and methods described herein. As shown, the configuration area 101 may be located in the upper right corner of the GUI 100. The configuration menu 440 may be opened (e.g., initiated or triggered to be displayed) by selecting a configuration area, or button, 101 in the GUI 100 shown in FIG. 8. The configuration menu 440 may include features for saving 442 and loading 444 songs, clearing an entire song, and exporting 446 a song to a file such as mp3 file. The configuration menu 440 could also be described as being the “home” to any audio, graphical or functionality options. Further, the menu 440 could also be described as being the “home” for sharing music created using the exemplary systems and methods with friends through various social media applications. As shown, the configuration menu 440 may further include a new project area 445 to start a new project, a plurality of saved files 447 for saving files to or loading files from, and a new file 448 area for creating a new save file. Additionally, the configuration menu 440 may further include a gyro button 103 as described herein.

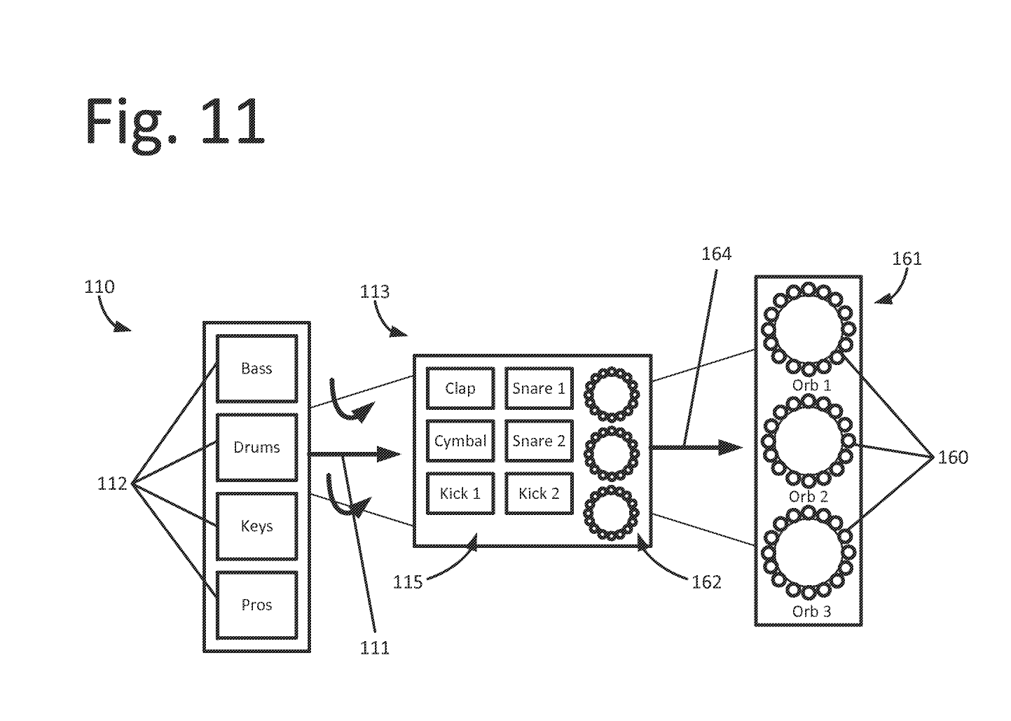

In at least one embodiment as shown in FIG. 11, sounds, or sound structures, 112 may be selected (e.g., touched) within the sound structure addition area 110 and the sound structure addition area 110 may transform 111 (e.g., flip, revolve, morph, etc.) into a specific sound structure addition area 113 that includes more specific sounds, or sound structures, 115 related to the sound structure 112 selected. For example, as shown, a user has selected the “Drums” sound structure 112, and as such, the specific sound structure addition area 113 includes a plurality of different “Drums” sounds, or sound structures, 115 that may be added or used within the music portion space 102. Additionally, already-created or preset sound structures 162 related to “Drums” may be located in the specific sound structure addition area 113. Selection of the one of the specific sounds 115 or sound structures 113 may transform 164 the specific sound structure addition area 113 into another menu 161 that allows selection of the specific sound structures 160 (e.g., touch and drag the sound structure into the music portion space 102). Additionally, prior to selection of a specific sound structure 160, a user may preview the sound or sound structure 115, 160 by briefly selecting it (e.g., touching or clicking it) to trigger the sound apparatus to play or output the sound or sound structure 115, 160.

A sound, or sound structure, 112 is shown being dragged 124 from the sound structure addition area 110 to the music portion space 102 in FIG. 3B. After the sound structure 112 has been moved to the music portion space 102, the sound structure 12 may define a continuous sound structure 114, which will be described further herein with reference to FIG. 4. The GUI 100 further includes a play/pause button 150 that a user may select to play or pause music presently being created on the GUI 100, an arrangement mode area, or button, 151 that a user may select to switch to Arrangement Mode 80, a song mode area, or button, 152 that a user may select to switch to Song Mode 90, and a tempo adjustment area 130 that a user may use to adjust the tempo of the continuous sound structures 114 located in the music portion space 102.

It may be described that the exemplary embodiments include collections of music sounds located in folders on a rotating menu within the sound structure addition area 110 such as, e.g., drums, bass, keys, pads, etc. A collection of sound samples may be located within each folder relative to the many stylings of the primary sound file (e.g., sub kick. Detroit High Hat, lo-fi snare, etc. can all be accessed from the “Drums” folder). Further, users may be able to extend the smaller samples and expand their sound file library by unlocking such features as add-on paid content. To manipulate a sample, users may drag the associated sound structure or orb into the spatiotemporal music space. Sounds can be previewed by touching their respective buttons in the menu. Once an appropriate sound is selected, the sound can be dragged from the menu to any position on screen. As described herein, the volume of each continuous sound structure 114 directly correlates to where the continuous sound structure 114 is dropped in the music portion space and the position of the continuous sound structure relative to the user affects how the sound is heard from the speakers. After a continuous sound structure 114 has been placed, a user should notice a highlighted sound element (e.g., blue highlighting) circling the continuous sound structure 114, much like a clock ticking.

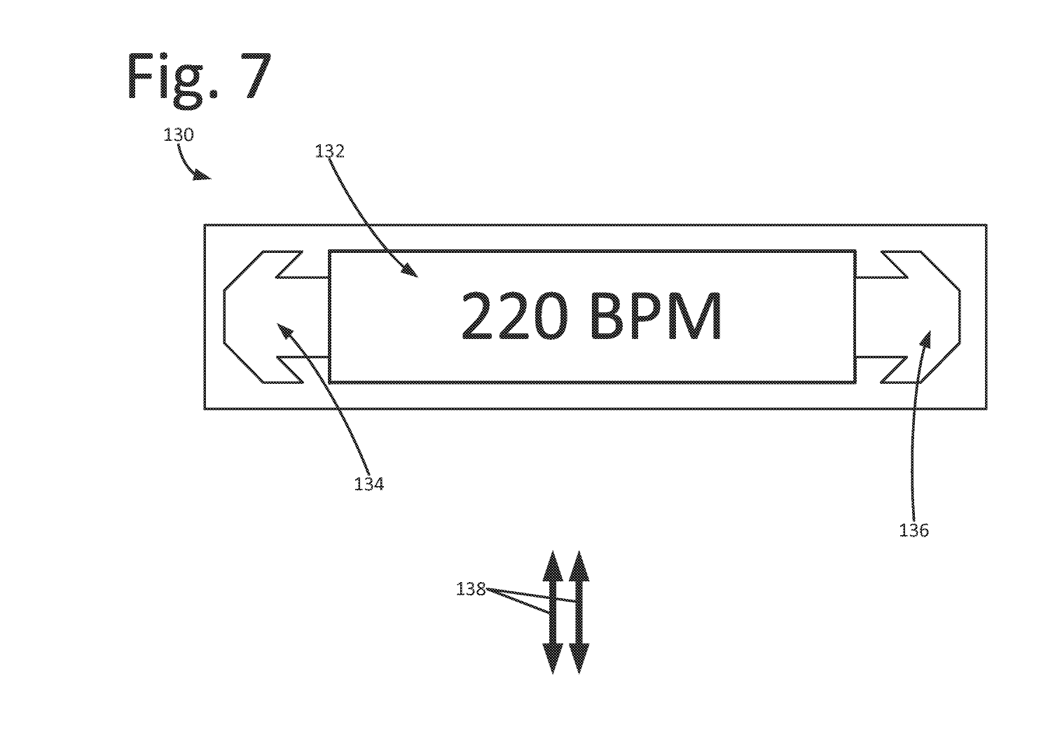

An enlarged view of the tempo adjustment area 130 is depicted in FIG. 7. The tempo adjustment area 130 includes a textual description 132 that displays or recites the current tempo (as shown, 220 beats per minute (BPM)), a decrease tempo area or button 134, and an increase tempo area or button 136. Each of the decrease tempo and increase tempo areas 134, 136 are in the shape of an arrow extending in opposite directions to, e.g., represent decreasing or increasing the tempo. Additionally, in one or more embodiments, a user may use a two-finger swipe 138 (e.g., two fingers contacting a touch screen near each other and moving at the same time), either upwards or downwards, anywhere within the GUI 100 to increase or decrease, respectively, the tempo of the music portion space 102.

In other words, it may be described that if a user wants to change the tempo of a continuous sound structure 114, the user may touch the tempo adjustment area, or meter, 130 at the top right (e.g., top right corner) of the display. In at least one embodiment, a user can also use a two-finger swipe to adjust tempo. A tempo adjustment may also be reflected visually in the speed at which the highlight of the sound element cycles through the 16 steps (e.g., sound elements or orbs) about the continuous sound structure 114.

Each of the continuous sound structures 114 may be moved (e.g., selected/touched and dragged by a user) vertically to adjust the volume of the continuous sound structure 114 and horizontally to adjust the spatial orientation of the continuous sound structure 114 (e.g., about a three dimensional space). For example, to increase the volume of a particular continuous sound structure 114, the continuous sound structure may be moved upwardly 116, and to decrease the volume of a particular continuous sound structure 114, the continuous sound structure 114 may be moved downwardly 118. Further, for example, to move the spatial orientation (e.g., where the sound comes from when output using speakers, headphones, etc.) leftward, the continuous sound structure 114 may be moved leftward 122 in the space 102, and to move the spatial orientation rightward, the continuous sound structure 114 may be moved rightward 120 in the space 102. Additionally, in at least one embodiment, a sound structure 114 may be moved beyond the viewable window or region of the space 102, and thus, the user may rotate the computing apparatus, e.g., tablet computer, about the space 31 as described herein with respect to FIG. 15.

It may be described that the music portion space 102 is a three-dimensional music space and sound samples (e.g., continuous sound structures) may be dragged into the three-dimensional music space such that the sound samples correspond to the real-world spatial position that a user will hear the sound through sound output apparatus such as e.g., headphones, speakers, etc. (e.g., a continuous sound structure placed to the left in the three-dimensional music space will be heard from the left of the user such as through the left side speakers). The spatial orientation, or location, of a continuous sound structure 114 may be represented in the music portion movement area 140 located at the bottom of the display. For example, the central, or middle, window (out of the three windows) in the music portion movement area 140 may depict the entire music space 102 for the active measure or music portion. For example, if a first continuous sound structure 114 is located 90 degrees to the left and a second continuous sound structure 114 is located 90 degrees to the right within the music portion space 102, the sounds corresponding to those structures 114 will be output from 90 degrees to the left and 90 degrees to the right, respectively, through sound output apparatus. In other words, the first continuous sound structure 114 will play sounds or music from the left side of a user and the second continuous sound structure 114 will play sounds or music from the right side of a user. Further, 90 degrees left and right may be represented by tick marks on either side of the music portion movement area 140. It may be described that music portion movement area 140 may allow a user to control the panning or sound position of the continuous sound structures 114 visually.

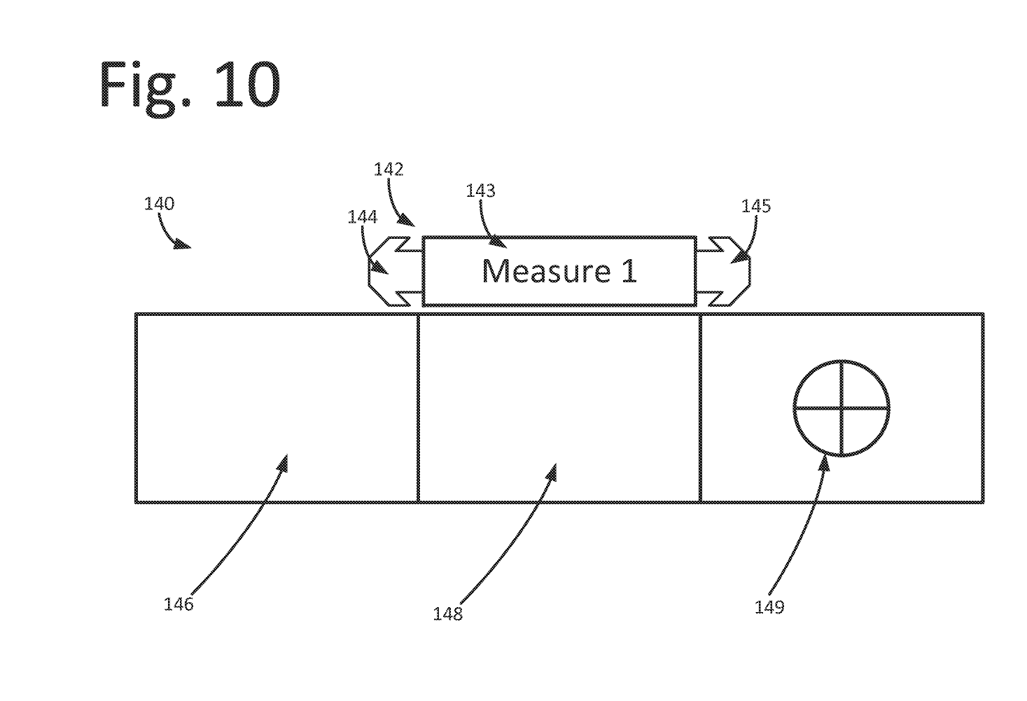

Further, the music portion movement area 140 may allow a user to add additional music portions (e.g., the rightmost window), view the current music portion in a zoomed-out view (e.g., the center window), and view the previously-created music portion (e.g., the leftmost window). An enlarged view of the music portion movement area 140 is depicted in FIG. 10. As shown, the music portion movement area 140 may include a previous portion area 146, a current portion area 148, and an add portion area 149. Additionally, the measures or portions may be traversed by using a portion selection area 142 that depicts the name of the current portion, or measure, 143 (e.g., as shown, “Measure 1”), a move-to-previous portion area 144, and a move-to-next portion area 145 (e.g., each of the previous portion and next portion are in the shape of an arrow extending in opposite directions to, e.g., graphically represent traversing through the portions or measures).

It may be described that the music portion movement area 140 may allow a user to change between music portions, or measures, that have been created in Loop Mode 50. The music portion movement area 140 displays the name 143 of the current music portion, or measure, in Loop Mode 50. The name of each music portion can be changed to better differentiate measures between one another. (e.g., names may include Drum Intro, Bass Drop, etc.). Each window within the music portion movement area 140 may described as being a viewport to allow a user to easily see the 360° layout of the current, previous, and next music portions or measures. Touching different music portions, or measures, in the viewport may give another quick alternative to changing measures. In at least one embodiment, the music portion movement area 140 and the viewports defined therein may allow a user to create new blank music portions if, e.g., at least one continuous sound structure 114 is located in the current, or present, music portion (e.g., because, otherwise, users from would be making multiple blank music portions). In at least one embodiment, if the music portion movement area 140 is taking up too much screen real estate or is unwanted, the music portion movement area 140 can be dragged down off screen and hidden until needed again.

As shown in FIG. 3C, more than one continuous sound structure 114 may be added to the music portion space 102. As shown, the “Keys” continuous sound structure 114 is located to the right and upward in comparison to the “Bell crash” continuous sound structure 114, and likewise, the “Keys” continuous sound structure 114 may have a greater volume and be spatially oriented more leftward than the “Bell crash” continuous sound structure 114. Such orientations are described further herein. Further, the current portion area 148 of the music portion movement area 140 may include graphical representatives of the sound structures 114 therein such that, e.g., a user can view the locations of the sound structures 114 with respect to at least a portion of the music portion space 102.

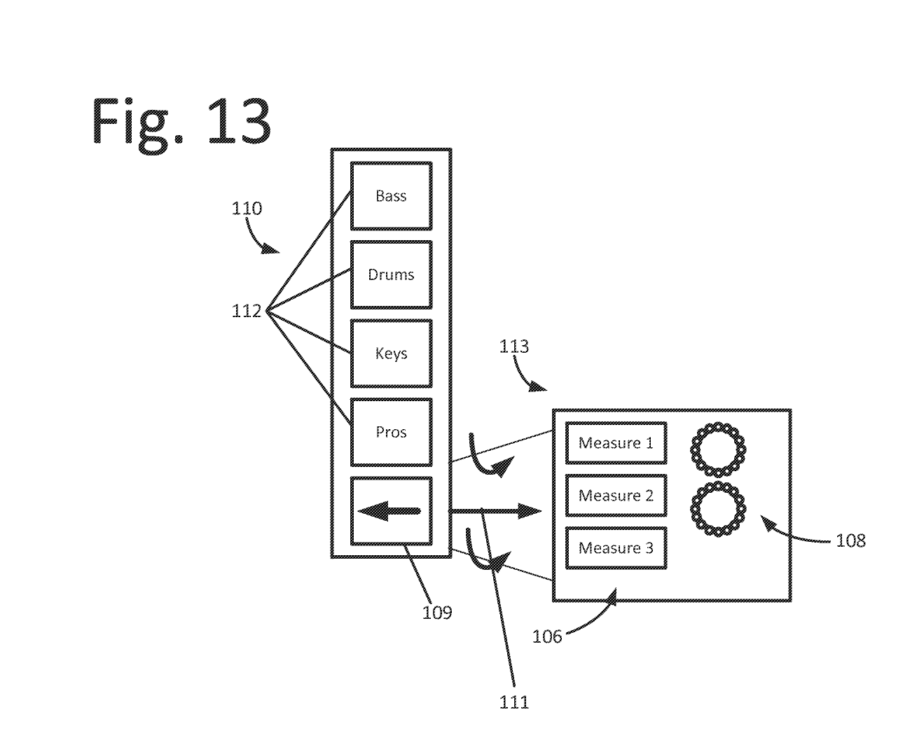

In at least one embodiment, once a music portion is created, a user may access copies of the music portion using area 109 of the sound structure addition area 110 (which may only appear after at least one music portion has been created). In other words, previously-created portions or measures may be saved and accessed within the sound structure addition area 110 such that a user may select such previously-created portions or measures to add them to the present portion or measure as shown in FIG. 13. For example, a user may select the area 109 to transform 111 the sound structure addition area 110 into a specific sound structure addition area 113 including a plurality of previously-created music portions or measures 106 and/or a plurality of previously-created sound structures 108. As shown in FIG. 3D, a user has selected the add portion area 149 and then selected the previously-created portion 106 from the sound structure addition area 110 (e.g., when viewing the music portion movement area 140, the portions appear the same).

A sound structure 114 may be removed, or deleted, from a music portion by selecting and dragging 117 the sound structure 114 to a trash area 119 as shown in FIG. 9. In other words, it may be described that the bottom-right of the display includes a “trash can” icon where users can drag sound structures or orbs for removal from the 3D spatiotemporal music space.

Additionally, continuous sound structures 114 may be “linkable” across music portions. As shown in FIG. 3D, both sound structures 114 are “linked,” which may mean that the sound structures 114 are linked to their corresponding sound structures 114 in another music portion or measure as represented by the “chain link” icon 107. When the sound structures 114 are linked to the corresponding sound structures 114 in another music portion, adjusting one sound structure 114 (e.g., increasing volume, moving spatial location, adjusting active/inactive sound elements, etc.) will also affect the other corresponding, or linked, sound structure 114 in another music portion or measure. Additionally, when deleting or removing a linked sound structure 114, the GUI 100 may alert a user that the sound structure 114 is linked and ask the user whether they would like to remove all linked sound structures 114 or only the sound structure 114 in the present music portion.

In at least one embodiment, when a previously-used or previously-created music portion measure is copied or previously-used or previously-created continuous sound structure is added to a music portion (e.g., dragged into the music portion space), the continuous sound structures 114 may be become linked to the previous music portion from where it came. This “linking” means that the positions, or configurations, of the continuous sound structures 114 in both music portions are shared. For example, the states and pitches of the continuous sound structures 114 may be copied over from the original music portion to the next. Further, linking continuous sound structures 114 in music portions may allow a user to retain sound positions and/or frequencies in the music space throughout an entire composition. These positions may be demonstrated in the music portion movement area 140 located at the bottom of the display. For example, moving a linked continuous sound structure 114 in the original portion may cause the linked continuous sound structure 114 in the new music portion to follow its positioning (e.g., vertical for volume, horizontal for spatial positioning, etc.).

Further, in one or more embodiments, a link button (e.g., located at the top of the individual continuous sound structure) may be available so users can control automation with ease (e.g., the dynamics of the sound file in the music space, such as panning and volume placement). For example, by linking and unlinking continuous sound structures 114, users can arrange continuous sound structures 114 moving from one frequency and volume level in the music space to another between music portions (e.g., a continuous sound structure 114 could move from the extreme left to right from one music portion to the next).

Edit Mode 70, which is shown in FIG. 4, may be initiated or triggered by a user selecting an individual sound structure 114 from the Loop Mode as shown in FIGS. 3A-3D. As shown, a continuous sound structure 204 is depicted in the space 202 of an exemplary Edit Mode graphical user interface (GUI) 200. It may be described that in Edit Mode 70, the selected continuous sound structure 204 jumps to the front of the screen as a larger image in order for the user to manipulate the parameters of beat mapping, pitch, and effects more easily. In other words, it may be described that a user may to touch a continuous sound structure 114 in Loop Mode 50 to bring the continuous sound structure closer to the user and in front of all other continuous sound structures 114 so that it can be more easily manipulated. More specifically, the display may “zoom in” on the selected sound continuous sound structure 114, 204. After a particular continuous sound structure 114, 204 has been selected for Edit Mode 70, a user can map beats, control pitch, manage tempo, and add effects to each sound element 220, or smaller orb, of the continuous sound structure 204.

As shown in FIG. 4, the continuous sound structure 204 includes a plurality of sound elements 220 arranged about a continuous loop representing a period of time. The continuous sound structure 204 may further include an identifier 225 (as shown in FIG. 4, “Bell Crash”). Although a circle is depicted, a loop of any shape may be used as a continuous sound structure 204 (e.g., circle, square, octagon, oval, etc.). The continuous sound structure 204 may be defined as being “continuous” because it is repetitive and does not define an end. Instead, if one were to describe a portion of the continuous sound structure 204 as a starting location, the ending location would be adjacent the starting location such that a complete loop will have been made. In this example, the continuous sound structure 204 includes 16 sound elements 220, each representing 1/16th of the period of time that the continuous sound structure 204 represents. For example, the continuous sound structure 204 could represent 1 second, and therefore, each sound element 220 may represent 1/16 of a second. Generally, the tempo of a music portion may be adjusted, which in turn, adjusts the period of the continuous sound structures 114 located in the music portion space 102 described herein with reference to FIGS. 3A-3D.

Each of the plurality of sound elements 220 may be configurable between an enabled, or active, configuration and a disabled, or inactive, configuration. When a sound element 220 is in the enabled configuration, the enabled sound element 220 represents a sound to be output at the moment of time within the period of time where the enabled sound element is located in the continuous loop of the continuous sound structure 204. Likewise, a disabled sound element 220 represents no sound to be output at the moment of time within the period of time where the enabled sound element is located in the continuous loop of the continuous sound structure 204. A user may enable or disable a sound element 220 by touching the sound element 220 when using the GUI 200 on a touchscreen device or tablet.

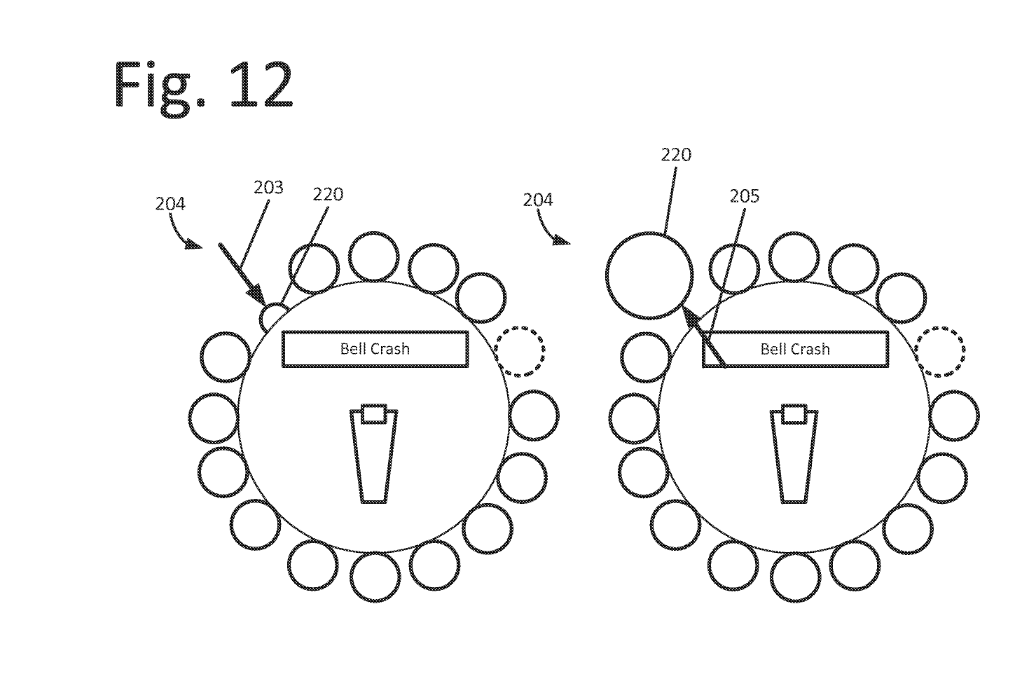

The pitch of each of the sound elements 220 may be adjusted by selecting and moving the sound element upwardly or downwardly 226 in the three-dimensional space 202 defined by the GUI 200. For example, as shown in FIG. 12, a user may select a sound element 220 and move it downwardly towards 203 the center of the sound structure 204 to adjust the pitch lower. Conversely, a user may select a sound element 220 and move it upwardly away 205 from the center of the sound structure 204 to adjust the pitch higher. It may be described that Edit Mode 70 provides the ability to change the pitch of a single beat sound element 220 of a continuous sound structure 204. For example, as shown, dragging a beat/sound element 220 upwards may raise the pitch of the beat/sound element 220 while dragging a beat/sound element 220 downwards may lower the pitch of the beat/sound element 220. Such functionally may provide users freedom in being able to customize the individual sound elements 229. In at least one embodiment, each beat/sound element 220 may be adjusted to one of 25 different, or unique, tones (e.g., shown numerically from −12 to 12 which provides 25 tone options in a scale that includes “0”).

It may be described that once in Edit Mode 70, a user may apply one or more (e.g., two) sound effects/modifiers by, e.g., dragging effects file(s) from a sound effect addition area/menu 210 on the left-hand side of the display. For example, such effects may include low and high pass filters, band pass, reverb, distortion, delay, compression, octave accentuation, flange, wah effects, phase effects, stereo/movement effects, etc. Further, as a mixing option, continuous sound structures 204 can be isolated within the measure with the solo button 223 located on the right side of the continuous sound structure 204 in Edit Mode. When the solo button 223 is selected, a user will only hear the selected continuous sound structure 204, which may allow greater control in determining volume level and frequency position as it relates to the spatiotemporal music space.

Additionally, the volume of the continuous sound structure 204 may be adjusted by using the slider 230. For example, a user may select and move a portion of the slider upwardly and downwardly 232 to adjust the volume of the continuous sound structure 204. It may be described that Edit Mode 70 may provide a user the ability to adjust (e.g., increase or decrease) the volume of a continuous sound structure 114 by, e.g., sliding a slider up and/or down. The continuous sound structures 114 may be stationary on the display until Edit Mode 70 is exited (e.g., by another touch). Still further, when a user manipulates the volume of each continuous sound structure 114, the volume adjustment may also be visually represented in the music portion movement area 140 at the bottom of the display. Once Edit Mode 70 is exited after volume change, the continuous sound structures 114 will be located in their new location corresponding to the new volume adjustment (e.g., located in a different vertical location within the music portion space 102 based on the new volume adjustment).

When the continuous sound structure 204 is being played, a visual indication 222 may be presented to indicate which sound element 220 is currently playing. The visual indication 222 may include a different color or highlight (e.g., glowing, blinking, etc.) for the actively-playing sound element 220. The visual indication 222 may continue clockwise 224 around the continuous sound structure 204 throughout the time period of the continuous sound structure 204.

Sound effects 216 may be added to the continuous sound structure 204 to affect one or more of the sound elements 220 or the entire continuous sound structure 204. The sound effects 216 may be added 214 from a sound effect addition area 210 which may include a plurality of sound effects 212 such as, e.g., low pass filters, high pass filters, reverb, etc.

Arrangement Mode 80, which is shown in FIG. 5, may be initiated or triggered by a user selecting the arrangement mode area 151 from the Loop Mode 50 as shown in FIGS. 3A-3D. As shown in FIG. 5, the Arrangement Mode 80 includes a graphical user interface (GUI) 300 that defines a space 302 and a continuous music arrangement 304 located in the space 302. The continuous music arrangement 304 may include a plurality of locations 320 arranged around a continuous loop representing a period of time. Additional locations 320 may be added to the continuous music arrangement 304 by selecting the “plus” button 330.

One or more previously-created music portions 312 (e.g., created using the GUI of FIGS. 3A-3D) may be added to one or more locations 320 of the continuous music arrangement 304 by selecting and moving 314 the music portions 312 from the music portion addition space 310 to one or more locations 320 of the continuous music arrangement 304. After at least one music portion 312 has been added to the continuous music arrangement 304, the continuous music arrangement 304 may provide a playable song. The song may be played using a play/pause button 340. Additionally, after a music portion 312 has been moved to a location 320, the location 320 may be moved 322 upwardly and/or downwardly to increase and/or decrease, respectively, the number or amount of times the music portion 312 should be played at that location (e.g., repeat at that location such as 2 times, 3 times, 6 times, etc.).

It may be described that, once in Arrangement Mode 80, a user may have the ability to choose how many locations 320 and/or music portions in specific locations 320 may be added to the song. In at least one embodiment, a user may utilize up to 16 locations 320 in a song. In other embodiments, a user may utilize more or less than 16 locations 320 in a song. Locations 320 (for the addition of measures or music portions) may be arranged in a loop defining a continuous music arrangement 304 that may operate in a similar fashion as the continuous sound structures described herein (e.g., one at a time, clockwise, etc.). The locations 320 may be visually indicated (e.g. visually indicated as being red) as being empty in Arrangement Mode 80. A measure, or music portion, may be selected and moved (e.g., dragged) from the music portion addition space 310 onto the locations 320. Further, locations 320 on the continuous music arrangement 304 can stay blank if the song being created is intended to have one or more music portions or measures of silence. Similar to as described herein with respect to the continuous sound structures 114 in Loop Mode 50, the continuous music arrangement 304 in Arrangement Mode 80 will play, traverse, or increment, in a clockwise manner, but the scale may be 16 sections or beats per single music portion (e.g., which is an example of the fractal design strategy).

In at least one embodiment, dragging music portions, or measures, onto the locations 320 of continuous music arrangement 304 may cause the colors of the locations 320 to change to let the user identify the order of the music portions, or measures, in the song. A music portion may be played multiple times on the same location 320 on the continuous music arrangement 304 by increasing a number of repeats for a given location 320. For example, the number of repeats of an individual music portion at a location 320 may be increased by dragging the location 320 upwards and may be decreased by dragging the location 320 downwards. When a music portion is dragged to a location 320, the number of repeats may default to 1. In at least one embodiment, when a music portion is being played in Arrangement Mode 80, the visual indication of the number of repeats may decrease in the location 320, stepwise, as each repeat of the music portions is completed, which may allow the user to more easily track the progression of the song.

Further, music portions can be removed from a location 320 of the continuous music arrangement 304 if a user desires, which may be accomplished by a longer touch on the targeted location 320 where the music portion has been located. If location 320 does not have a measure, the entire location 320 may be removed from the sequence, or song, and the remaining location will be moved up in the playing order accordingly.

In one or more embodiments, the exemplary continuous sound structures described herein may be referred to as a “sound orb.” A continuous sound structure may described as being a spherical representation of musical beats with a central large orb (e.g., disc, circle or sphere), surrounded by 16 smaller orbs, which each represent 1/16th of a particular sequence of sounds making up a single “loop.” Examples of the sounds produced by each smaller orb (e.g., element around the sound orb) include, but are not limited to, bass, drums, keys, and pads, one shots, and variations thereof. The controls for the volume of the sounds associated with each sound orb may reside in the central large orb. Volume may be represented by a scale that can be adjusted by touch (e.g., touching and dragging the volume indicator up or down to increase or decrease the volume, respectively). The volume level of each sound orb is also linked to the sound orb's vertical location in the “sound space” (e.g., music portion space). Specifically, the user can adjust the vertical position of the sound orb to adjust the volume of that specific sound orb within a 3-dimensional (3-D) arrangement of multiple sound orbs (e.g., other sound orbs independent from one another within the same 3-D space). Changing the vertical position of a sound orb will also change the volume in the volume control within that particular sound orb, and vice versa. In other words, the volume changes will be “mirrored.”

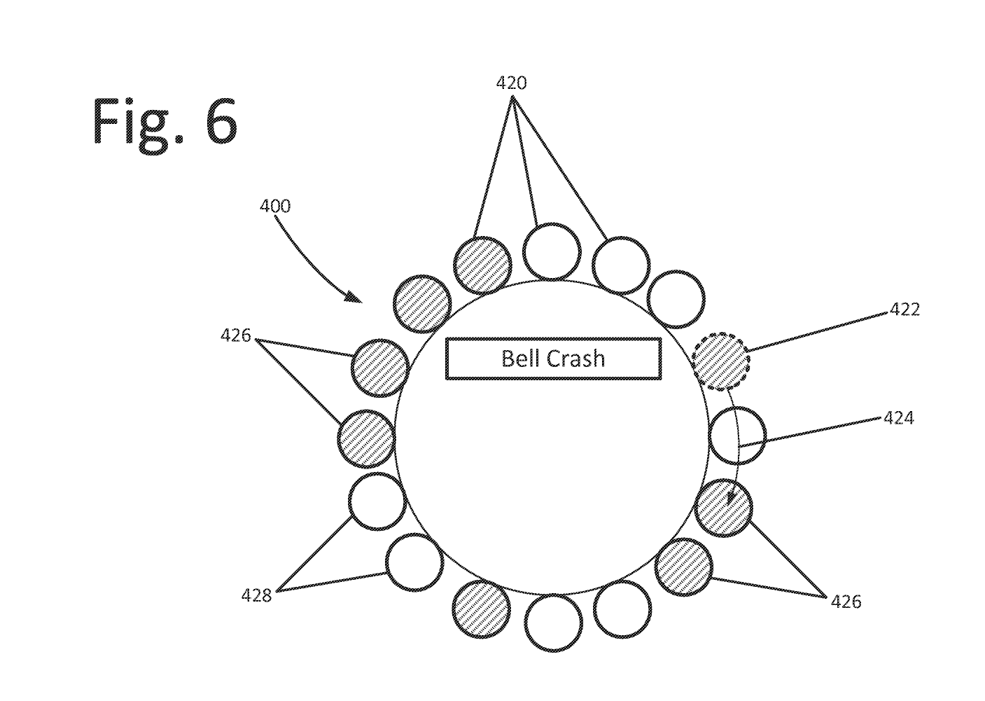

A continuous sound structure 400 is depicted in FIG. 6. As shown, the sound elements, or smaller orbs, 420 that surround the continuous sound structure, or central larger orb, 400 generate the “beats” of the sound file associated with the sound. These sounds may be generated when the sound elements 420 are “active.” The activated sound elements 420 may be visually indicated as being active 426 (e.g., color-indicated such as a different color than non-activated orbs) or inactive 428. In at least one embodiment, the elements 420 are active 426 when green and inactive 428 when red. The user may control the activity of these beat elements 420 by simply touching them (e.g., user touches beat orb=active, touch again=off, inactive).

The generation of sounds within a specific sound element 420 may be delineated by a sweeping orbital indicator light 422 (represented by a dashed circle in FIG. 6). In one or more embodiments, indicator light may be the color blue. More specifically, each smaller orb 420 may be lighted in turn in a clockwise fashion 424 with a blue light 422, with one complete circumferential transition constituting a single “loop.” In at least one embodiment, each continuous sound structure 400 includes 16 sound elements 420, or smaller orbs, each of which comprises 1/16th of a “sound loop,” or period of time of the continuous sound structure 400. Although this embodiment utilizes 16 sound elements 420, it is to be contemplated that other embodiments may utilize more or less sound elements 420, and/or the number, or amount, of sound elements 420 may be user selectable. For example, a user may choose to include 8 sound elements 420 for each continuous sound structure 400 and each of sound elements may represent ⅛th of a sound loop. The time taken for the “blue” indicator to complete a single “loop” is tied to, or directly related to, the “tempo” of the continuous sound structure 400.

As described herein with respect to FIG. 3B and FIG. 7, the song tempo, as beats per minute (BPM), may displayed in the top right hand corner of the 3-D music space by a “slider.” The tempo can be altered by touching arrows to the left or right of the slider, or via a two finger vertical swipe. The track tempo is also represented on the sound orb by the speed in which the blue illumination cycles through the 16 beat orbs surrounding the central volume orb.

The current BPM may be shown at all times during both Song and Loop Modes 90, 50 and may allow for easy access to change the tempo of the song. In at least one embodiment, when BPM is modified, it may be changed for the entire song (e.g., each measure or music portion) the user is composing. In at least on embodiment, each individual measures, or music portion, may have different, user selectable tempos. In at least one embodiment, the BPM may be user settable, or selectable, between 50 and 250.

The position of the continuous sound structures within the three dimensional music space that houses (e.g., within which the sound orbs may be located) the continuous sound structures may determine the position of the sound for the user (e.g., a sound orb placed to the back of the space will be heard from behind the user), which may allow a user control of the panning, or sound position, of the continuous sound structures visually. In other words, the exemplary embodiments described herein provide 360 degrees of sound manipulation (e.g., the location of where the sounds/music of each sound structure may be selected by moving it within the music portion space).

The embodiments described herein may include collections of music sounds located in folders on a rotating menu (e.g., a sound structure area) on the left-hand side of the tablet display (e.g., drums, bass, keys, and pads, etc.) as shown in FIGS. 3A-3D and FIG. 11. A collection of sound files that relate to the primary sound may be located within each folder. For example, sub kick, Detroit High Hat, and lo-fi snare can all be accessed from the “drums” folder. Further, in at least one embodiment, users may be able to extend the sound file library by unlocking them through an in-app purchase system.

Loop Mode 50, as shown in FIGS. 3A-3D, may be the starting point for the exemplary systems and methods. In Loop Mode 50, users have the freedom to create measures, or music portions, that may be part of their composition by picking and editing sounds from a rotating sound structure menu. Loop Mode may play a continuous loop of the current mode the user is editing, which allows the user to hear the effects of the changes made to individual, smaller orbs (e.g., sound elements) or the spatiality of sounds as the user's view changes.

Arrangement Mode 80, as shown in FIG. 5, may allow the user to compose at a larger scale using all measures, or music portions, created during Loop Mode 50. The Arrangement Mode 80 may be described as being the second level of a “fractal” view on song making. Whereas, each sound element in Loop Mode 50 represents a single beat of a sound, each location in Arrangement Mode 80 represents one or more loops of a single music portion or measure. The user can specify a song length by adding music portions to the composition or increasing the number of times a certain music portion repeats within the composition.

Song Mode 90 may be selected from by selecting the song mode button 152 from Loop Mode 50 of FIGS. 3A-3D. In Song Mode 90 as shown in FIGS. 14A-14B, users can observe the song as it plays out music portion by music portion within a graphical user interface 170 based on the composition created in Arrangement Mode 80. For example, continuous sound structures 114 of the music portions arranged in Arrangement Mode 80 may slide downwardly across the GUI 170 as they are being played.

Song Mode 90 may be further described as a rich, visual representation of the song or music built in Arrangement Mode 80. Song Mode 90 may be accessed once an arrangement, or song, has been created and may be toggled on/off from Loop Mode 50. When Song Mode 90 is activated, the first measure, or music portion, of the song/composition may be loaded on screen. In at least one embodiment, Song Mode 90 will start paused so that the user can start it when they desire.

When Song Mode 90 begins to play, the music portions will play for the amount of repeats that were specified in Arrangement Mode 80, and then the next music portion in the arrangement may drop down from above into the current view (e.g., replacing the sound orbs, or continuous sound structures, from the previous measure, or music portion). Further, in Song Mode 90, a user may have the ability to navigate around the 360° scene while the song is playing to get a different vantage and listening point for the song (e.g., a user may change his/her spatial orientation with respect to the song). Still further, from Song Mode 90, a user may toggle back into Loop Mode 50 of the currently playing measure, or music portion, to make changes (e.g., low level changes) and/or toggle back into Arrangement Mode 80 to make composition changes.

In one or more embodiments, alongside the automation/dynamics feature, the exemplary systems and methods may be programmed for note length. For example, this note length feature may allow users to create variable note arrangements and melodies without the tediousness of navigating between measures (e.g., a note can play and stop at intervals set by the user on the sound orb). This note length feature may shorten the time to completion and may provide intricacy in note manipulation. Further, the note length feature may be visually represented by a colored line that connects the beat orbs around the core sound orb that holds the sound file. In at least one embodiment, a lighting effect may provide cosmetic appeal to the intricacy of this feature.

One or more embodiments may have the ability to record vocals and place the created files into the music space as a continuous sound structure, or sound orb. Further, this same recording feature may also be available for MIDI controllers and other traditional analog instruments (e.g., guitar, bass, etc.).

Further, one or more embodiments may have an export feature that may allow a user's songs to be compressed into a sound file (e.g., MP3, Wave, etc.) for sharing on social media platforms (e.g., FACEBOOK, TWITTER, SOUNDCLOUD, etc.) and/or another specific online portal for sharing.

Still further, one or more embodiments may include a spectral analysis mode that may map the sounds of the created beats to the backdrop of the sound wall. As such, each composition may have a unique visualization of the music being played that may enrich the overall experience for the user.

As described herein, the primary user interface may be through the tablet touch screen, using direct manipulation techniques for interaction with the instrument selection interface and rhythm orbs. Changes in viewpoint will be provided through two mechanisms. The first is a swipe based interface that allows students to rotate the scene by using their fingers to swipe left, right, up, or down with corresponding view changes.

In addition, modern tablets have motion-sensing capability through integrated inertial sensors. The exemplary systems and methods may use these capabilities to enable immersive kinesthetic viewing of the 3D composition as shown in FIG. 15. For example, a user may keep the tablet held straight in front of their eyes (at a normal viewing distance) as they rotate their head. The motion sensors will track the orientation of the tablet, and the rendering perspective will be adjusted to provide the sense that the user is viewing the virtual world from within it, e.g., from an egocentric perspective, rather than viewing the virtual world from afar. The audio will also adjust accordingly, such that if the user faces a rhythm orb object, it will sound as though it is in front of them, and if there is another rhythm orb to the left, it will sound as though it is to the left.

In at least one embodiment, a structure for progressive achievement (such as, e.g., gaming) may be provided and for enabling users to share their compositions with others. For example, two modes may exist: Training Mode and Game Mode. Training Mode may not be defined to be used with regard to whether it is a solitary or social activity. In Training Mode, users will be gradually introduced to the interface and features through a series of tutorial “levels,” as is commonly found in video games. Users will be asked to match goal configurations as closely as possible. The closer the user comes to directly matching the pre-constructed goal, the higher their “grade” for a given round. Training Mode may encourage players to explore the space in ways that they might not know were possible. For example, the first tutorial may be to simply add a single drum sound and have that sound have ½ of its beats in the sequence turned on, followed by tutorials on changing pitch, adding sound effects, and mixing sounds spatially.

Game Mode may be subsequent to the training mode and may be a single player experience. In Game Mode, students will be challenged to demonstrate their proficiency with the interface based on their ability to utilize the functionalities introduced during Training Mode. For example, the tutorial levels will correlate with gameplay levels. Further, teachers may guide students with regard to the “difficulty” of implementing different music functionalities (e.g., beat frequency, sound pitch, sound effects, spatial orientation of sounds). For example, students may be provided with audio-only examples of music samples, and may need to replicate the music with their spatial composition. To move on to the next level, the music may need to be within an empirically determined percentage from the original music with subsequent levels becoming increasingly more complex in terms of the number of instruments, and spatial arrangement of those instruments.

Some students may likely find the sharing of their compositions the most compelling aspect of creating musical works and the exemplary embodiments described herein may incorporate a number of “social game mechanics” that encourage users to share and explore the works of others. Players will be able share their work with one another and rate the work of others. Creations may be “thumbed up” indicating that someone likes a given audio track. Players will also be able to remix the work of others, though a remixed song will always reference its original creator as well as those who remix a track. As players contribute more songs to the community, those that acquire “thumbs up” and have their tracks remixed by others will move up the player ranking boards. Finally, badges can also be defined for particular kinds of compositions or those that make use of techniques introduced through the challenge mode of the game. This may encourage players to experiment with different kinds of audio constructions in the virtual space. For example, one badge, possibly called the “Interpretive Dance Badge,” would require movement on the part of the listener to achieve a “proper” listening of the audio track. All social interaction features will be accessible through the tablet interface using, e.g., a secure server for storage. Students may be assigned an anonymous ID for use with the app to protect their identities, although only students, their teachers, and the researchers will have access to the data.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A system for allowing a user to create music, the system comprising:
computing apparatus configured to generate music;
sound output apparatus operatively coupled to the computing apparatus and configured to output sound generated by the computing apparatus;
an input interface operatively coupled to the computing apparatus and configured to allow a user to create a portion of music; and
a display apparatus operatively coupled to the computing apparatus and configured to display a graphical user interface,
wherein the computing apparatus is configured to:
depict a music portion space in the graphical user interface of the display apparatus for creating the portion of music, and
allow a user, using the input apparatus, to add one or more continuous sound structures to the music portion space, wherein each of the one or more continuous sound structures comprises a plurality of sound elements arranged around a continuous loop representing a period of time.

2-3. (canceled)

4. The system of claim 1, wherein the computing apparatus is further configured to execute allowing a user, using the input apparatus, to move each continuous sound structure of the one or more continuous sound structures vertically within the music portion space to adjust the volume of the continuous sound structure.

5. The system of claim 1, wherein the computing apparatus is further configured to execute: depicting a sound structure addition area on the graphical user interface for displaying a plurality of continuous sound structures to be used in the music portion space to create the portion of music, and
allowing a user, using the input apparatus, to add one or more continuous sound structures to the music portion space using the sound structure addition area.

6. The system of claim 1, wherein the computing apparatus is further configured to execute allowing a user, using the input apparatus, to move each continuous sound structure of the one or more continuous sound structures horizontally within the music portion space to adjust the spatial orientation of the continuous sound structure.

7. The system of claim 1, wherein the computing apparatus is further configured to execute: depicting a tempo adjustment area on the graphical user interface for displaying a tempo of the portion of music, and
allowing a user, using the input apparatus, to adjust the tempo of the portion of music using the tempo adjustment area of the graphical user interface.

8. The system of claim 1, wherein the computing apparatus is further configured to execute: depicting a music portion movement area on the graphical user interface for displaying additional music portions, and
allowing, using the input apparatus, a user to switch to another music portion and to add another music portion using the music portion movement area of the graphical user interface.

9. The system of claim 1, wherein the computing apparatus is further configured to execute allowing, using the input apparatus, a user to select a continuous sound structure from the music portion space to edit the continuous sound structure.

10. A system for allowing a user to create music, wherein the system comprises:
computing apparatus configured to generate music;
sound output apparatus operatively coupled to the computing apparatus and configured to output sound generated by the computing apparatus;
an input interface operatively coupled to the computing apparatus and configured to allow a user to edit a continuous sound structure;
a display apparatus operatively coupled to the computing apparatus and configured to display a graphical user interface,
wherein the computing apparatus is configured to:
depict the continuous sound structure on the graphical user interface, wherein the continuous sound structure comprises a plurality of sound elements arranged around a continuous loop representing a period of time, wherein each of the plurality of sound elements are configurable using the input apparatus between an enabled configuration and a disabled configuration, wherein, when a sound element is in the enabled configuration, the enabled sound element represents a sound to be output at the moment of time within the period of time where the enabled sound element is located in the continuous loop, and
allow, using the input apparatus, a user to select one or more of the plurality of sound elements to configure the one or more sound elements in the enabled or disabled configurations.

11-12. (canceled)

13. The system of claim 10, wherein the computing apparatus is further configured to execute allowing, using the input apparatus, a user to change the pitch of one or more sound elements of the plurality of sounds elements.

14. The system of claim 10, wherein the computing apparatus is further configured to execute, when a user changes the pitch of a sound element, changing the depth of the sound element in the graphical user interface.

15. The system of claim 10, wherein the computing apparatus is further configured to execute:
depicting a sound effect addition area on the graphical user interface for displaying a plurality of sound effects to be used to modify one or more sound elements of the plurality of sounds elements, and
allowing, using the input apparatus, a user to add one or more sound effects to one or more sound elements space using the sound effect addition area.

16. The system of claim 10, wherein the computing apparatus is further configured to execute:
displaying a volume adjustment element, and
allowing, using the input apparatus, a user to adjust the volume of the continuous sound structure using the volume adjustment element.

17. A system for allowing a user to create music, wherein the system comprises:
computing apparatus configured to generate music;
sound output apparatus operatively coupled to the computing apparatus and configured to output sound generated by the computing apparatus;
an input interface operatively coupled to the computing apparatus and configured to allow a user edit a continuous music arrangement to create music;
a display apparatus operatively coupled to the computing apparatus and configured to display a graphical user interface,
wherein the computing apparatus is configured to:
depict the continuous music arrangement, wherein the continuous music arrangement comprises a plurality of locations arranged around a continuous loop representing a period of time,
allow a user, using the input apparatus, to add one or more music portions to one or more locations of the plurality of locations of the continuous music arrangement, and
allow a user, using the input apparatus, to increase or decrease an amount of locations of the plurality of locations of the continuous music arrangement.

18-19. (canceled)

20. The system of claim 17, wherein the computing apparatus is further configured to execute:
depicting a music portion addition area on the graphical user interface for displaying a plurality of music portions, and
allowing a user, using the input apparatus, to add one or more music portions to one or more locations of the plurality of locations of the continuous music arrangement using the music portion addition area.

21. A method for allowing a user to create music, the method comprising:
depicting a music portion space in a graphical user interface of a display apparatus for creating a portion of music; and
allow a user, using input apparatus, to add one or more continuous sound structures to the music portion space, wherein each of the one or more continuous sound structures comprises a plurality of sound elements arranged around a continuous loop representing a period of time.

22. The method of claim 21, wherein the method further comprises allowing a user, using the input apparatus, to move each continuous sound structure of the one or more continuous sound structures vertically within the music portion space to adjust the volume of the continuous sound structure.

23. The method of claim 21, wherein the method further comprises:
depicting a sound structure addition area on the graphical user interface for displaying a plurality of continuous sound structures to be used in the music portion space to create the portion of music, and
allowing a user, using the input apparatus, to add one or more continuous sound structures to the music portion space using the sound structure addition area.

24. The method of claim 21, wherein the method further comprises allowing a user, using the input apparatus, to move each continuous sound structure of the one or more continuous sound structures horizontally within the music portion space to adjust the spatial orientation of the continuous sound structure.

25. The method of claim 21, wherein the method further comprises:
depicting a tempo adjustment area on the graphical user interface for displaying a tempo of the portion of music, and
allowing a user, using the input apparatus, to adjust the tempo of the portion of music using the tempo adjustment area of the graphical user interface.

26. The method of claim 21, wherein the method further comprises:
depicting a music portion movement area on the graphical user interface for displaying additional music portions, and
allowing, using the input apparatus, a user to switch to another music portion and to add another music portion using the music portion movement area of the graphical user interface.

27. The method of claim 21, wherein the method further comprises allowing, using the input apparatus, a user to select a continuous sound structure from the music portion space to edit the continuous sound structure.

28. A method for allowing a user to create music, the method comprising:
depicting a continuous sound structure on the graphical user interface, wherein the continuous sound structure comprises a plurality of sound elements arranged around a continuous loop representing a period of time, wherein each of the plurality of sound elements are configurable using the input apparatus between an enabled configuration and a disabled configuration, wherein, when a sound element is in the enabled configuration, the enabled sound element represents a sound to be output at the moment of time within the period of time where the enabled sound element is located in the continuous loop; and
allowing, using an input apparatus, a user to select one or more of the plurality of sound elements to configure the one or more sound elements in the enabled or disabled configurations.

29. The method of claim 28, wherein the method further comprises allowing, using the input apparatus, a user to change the pitch of one or more sound elements of the plurality of sounds elements.

30. The method of claim 28, wherein the method further comprises, when a user changes the pitch of a sound element, changing the depth of the sound element in the graphical user interface.

31. The method of claim 28, wherein the method further comprises:
depicting a sound effect addition area on the graphical user interface for displaying a plurality of sound effects to be used to modify one or more sound elements of the plurality of sounds elements, and
allowing, using the input apparatus, a user to add one or more sound effects to one or more sound elements space using the sound effect addition area.

32. The method of claim 28, wherein the method further comprises:
displaying a volume adjustment element, and
allowing, using the input apparatus, a user to adjust the volume of the continuous sound structure using the volume adjustment element.

33. A computer-implemented method for allowing a user to create music, the method comprising:
depicting a continuous music arrangement, wherein the continuous music arrangement comprises a plurality of locations arranged around a continuous loop representing a period of time;
allowing a user, using an input apparatus, to add one or more music portions to one or more locations of the plurality of locations of the continuous music arrangement; and
allowing a user, using the input apparatus, to increase or decrease an amount of locations of the plurality of locations of the continuous music arrangement.

34. The method of claim 33, wherein the method further comprises:
depicting a music portion addition area on the graphical user interface for displaying a plurality of music portions, and
allowing a user, using the input apparatus, to add one or more music portions to one or more locations of the plurality of locations of the continuous music arrangement using the music portion addition area.
